(19) United States
(12) Patent Application Publication
(10) Pub. No.: US 2021/0023468 A1
(43) Pub. Date: Jan. 28, 2021

(54) COMMUNICATION METHODS BETWEEN PHYSICAL ROBOTIC DEVICES AND ENHANCEMENTS IN PHYSICAL ROBOTIC DEVICE AND ACTION FIGURE INTERACTIONS

(71) Applicant: Jon Burton, Malibu, CA (US)

(72) Inventor: Jon Burton, Malibu, CA (US)

(21) Appl. No.: 16/936,759

(22) Filed: Jul. 23, 2020

Related U.S. Application Data
(60) Provisional application No. 62/878,025, filed on Jul. 24, 2019.

(51) Int. Cl. A63H 30/04; A63H 5/00; B25J 13/00; B25J 11/00; B25J 9/16; B25J 13/08

(52) U.S. Cl. CPC A63H 30/04; A63H 5/00; B25J 13/006; B25J 11/003; B25J 9/1661; B25J 9/1679; B25J 13/088; B25J 9/1694; B25J 9/1653

(57) ABSTRACT

A method of transmitting light-based line-of-sight signals to schedule communications between a plurality of toy robotic devices includes receiving, at a first toy robotic device, a signal via a wireless communication network from a server toy robotic device; and transmitting, by the first toy robotic device, a waiting infrared pulse, via an infrared wireless network, to remaining toy robotic devices. The transmitting of the waiting infrared pulse if the signal command indicates the first toy robotic device is to transmit a signal representing a firing shot. The method also include waiting a predetermined amount of time and transmitting, by the first toy robotic device, an infrared digital signal via the infrared wireless network, to the remainder of the plurality of toy robotic devices and transmitting, by the first toy robotic device, a notification signal to the server toy robotic device to identify transmission of the infrared digital signals.

### RELATED APPLICATIONS

This application claims priority to application Ser. No. 62/878,025, filed Jul. 24, 2019, entitled “Improved Communication Methods Between Physical Robotic Devices and Enhancements in physical Robotic Device and Action Figure Interactions,” the entirety of which is hereby incorporated by reference.

### BACKGROUND OF THE INVENTION

Robots today perform a variety of actions. In addition, physical robots or robotic devices are utilized as toys and/or in games. Many of the physical robots or robotic devices are expensive due to the hardware and/or software components necessary to provide the physical robots or robotic devices with the ability to move from one location to another location as directed by users or operations; track other physical robots or robotic devices that other users or operators are utilizing and/or to perform operations and/or actions with respect to other users or operators robotic devices. These robots are not available to the normal consumer due to the robots expense.

### BRIEF DESCRIPTION OF THE DRAWINGS

FIG. 1 illustrates a toy robotic device according to some embodiments;

FIG. 2A illustrates a three-quarter view of a toy robotic device according to some embodiments;

FIG. 2B illustrates a top view of a toy robotic device with a top plate removed in order to view emitters and/or receivers according to some embodiments;

FIG. 3A illustrates an exploded view of a top portion of a toy robotic device according to some embodiments;

FIG. 3B illustrates an exploded view of a bottom portion of a toy robotic device according to some embodiments;

FIG. 3C illustrates a bottom view of a toy robotic device according to some embodiments;

FIG. 4A illustrates a method for establishing a wireless network between two or more robotic toy devices;

FIG. 5A illustrates a method of scheduling communications between a network of connected robot toy devices according to some embodiments;

FIG. 5B illustrates a timing diagram associated with the method of scheduling communications described in FIG. 5A according to some embodiments;

FIG. 6A illustrates an additional method or process of identifying line of sight between robotic toy devices according to some embodiments;

FIG. 6B illustrates a timing diagram for the process discussed in FIG. 6A according to some embodiments;

FIG. 7A illustrates a simple artificial intelligence process for toy robotic devices according to some embodiments;

FIG. 7B illustrates a second toy robotic device tracking and/or attacking a first toy robotic device according to some embodiments;

FIG. 8A illustrates coupling or connection of radio frequency identification (RFID) readers in a robotic toy device according to some embodiments;

FIG. 8B illustrates a toy action figure according to some embodiments;

FIG. 8C illustrates a toy action figure attached or connected to a top surface of the toy robotic device according to some embodiments;

FIG. 8D illustrates light pipes in a toy action figure according to some embodiments; and

FIG. 8E illustrates a block diagram of an action figure according to some embodiments.

### DETAILED DESCRIPTION OF THE INVENTION

The following detailed description and provides a better understanding of the features and advantages of the claimed subject matter described in the present disclosure in accordance with the embodiments disclosed herein. Although the detailed description includes many specific embodiments, these are provided by way of example only and should not be construed as limiting the scope of the claimed subject matter disclosed herein.

In the following detailed description, exemplary embodiments in which various aspects of the disclosure may be practiced are described in sufficient detail to enable those skilled in the art to practice the claimed subject matter. It is to be understood that other embodiments may be utilized and that logical, programmatic, mechanical, electrical and other changes may be made without departing from the spirit or scope of the present disclosure. The following detailed description is, therefore, not to be taken in a limiting sense, and the scope of the present disclosure is defined by the claims and equivalents thereof.

The description of the illustrative embodiments can be read in conjunction with the accompanying figures. Embodiments incorporating teachings of the present disclosure are shown and described with respect to the figures presented herein. The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices (processors, microprocessors, controllers and/or microcontrollers) and/or structures and can involve use of a combination of hardware, firmware, as well as several software-level constructs (e.g., program code and/or computer-readable instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general claimed subject matter.

In some embodiments, a network may also include for example, past, present and/or future mass storage, such as, network storage devices, server farms, cloud storage, cloud server farms, and/or other forms of computing and/or device readable media, for example. A network may also include a portion of the Internet (or global communications network), one or more local area networks (LANs), one or more wide area networks (WANs), wire-line type connections, one or more personal area networks (PANs), wireless type connections, one or more mesh communication networks, one or more cellular communication networks, one or more peer-to-peer wireless communication networks, other connections, or any combination thereof. In some embodiments, a network may comprise two or more computing devices so that signal communications, such as in the form of signal packets, for example, may be exchanged, such as between a server computing device and a client computing device and/or other types of devices, including between wireless devices coupled via a wireless network, for example. In some embodiments, the wireless devices may be wireless communication devices such as smart phones, cellular phones, tablets, laptop devices, etc.

Described herein is a robotic toy device that is able to efficiently communicate with other robotic toy devices, track other robotic devices position and/or engage in actions and operations (such as game play) with other toy robotic devices. In some embodiments, the toy robotic devices described herein may have less than $10 in component costs and thus affordable to normal consumers. In some embodiments, the toy robotic devices may include 1) a light transmitter and/or a light receiver (which may be an infrared light emitter or transmitter and/or an infrared light receiver) and 2) a wireless communication transceiver (which may be a wireless LAN transceiver (e.g., a WiFi transceiver), a cellular transceiver, or a personal area network (PAN) transceiver (e.g., Bluetooth or Zigbee). In some embodiments, the wireless communication transceiver may be a radiofrequency (RF) transceiver (but different from the listed transceiver), an ultrasonic communication transceiver and/or a magnetic communication transceiver, and may operate according to protocols utilizing RF transceivers, ultrasonic communication transceivers and/or magnetic communication transceivers.

In some embodiments, the utilization of both the light emitter/transmitter, the light receiver/detector and the wireless communication transceiver allows for different tasks to be performed by light emitter/transmitter and receiver/detector as compared to the wireless communication transceiver. In some embodiments, for example, the wireless communication transceivers of the toy robotic devices may be utilized to 1) schedule times or timeslots or transmissions or emissions from light emitters/transmitters on the toy robotic devices; 2) receive signal or transmission results (e.g., reception or detection of the light/emitter transmission or emissions, directions the transmissions or emissions were received from, and/or which toy robotic devices were involved); 3) receive additional parameters, measurements and/or statistics from the toy robotic devices (e.g., operational status of components and/or toy robotic devices and/or how many transmissions were made). In some embodiments, the wireless communication transceivers of the toy robotic devices may be utilized to setup, initiate and/or establish a wireless communication network between the different toy robotic devices engaged in a common action. Please note that although the singular version of transmitter/emitter, receiver/detector, and wireless communication transceiver may be utilized in the specification herein, the claimed subject matter also applies to multiple transmitters/emitters, receivers/detectors, and wireless communication transceivers being resident or included with a toy robotic device.

In some embodiments, because the wireless communication transceivers of the toy robotic devices are utilized for the tasks described above, the light transmitters/emitters and/or light receivers may be utilized communications directly between the toy robotic devices. In some embodiments, these tasks may be firing shots at one another in a firing shot game or a shooter game, as well as identifying times when shots may be fired. In some embodiments, for example, the toy robotic devices may utilize the light transmitters or emitters to communicate to other toy robotic devices that a light pulse or digital signal is coming (which may be referred to as a waiting pulse). In some embodiments, for example, the toy robotic devices may utilize the light transmitters or emitters to communicate firing shots or other parameters to other toy robotic devices in a shooting game. In some embodiments, because the light transmitter/emitters and/or receivers utilize line-of-sight, the toy robotic devices may transmit light pulses or signals from a plurality or all of the light emitters or transmitters at the same time. In some embodiments, the toy robotic device's light emitters or transmitters may be able to transmit or emit light to cover 360 degrees around the emitting or transmitting toy robotic device.

While the specification utilizes the term “toy robotic device”, this term may be utilized interchangeably with the phrases “robotic toy device,” “robotic device,” “toy device,” “toy robot device,” “robot,” and/or “robot device.” In addition, the techniques described herein may apply to other robotic devices or robots that are not toys. In some embodiments, for example, there may be a number of robot devices or robots networked together to form specific tasks (but still need to communicate with each other and understand positioning of the other robotic devices). The methods, processes, apparatuses and devices described herein may be utilized with respect to the networked robot devices or robots that are performing such a task. For simplicity and to minimize redundant copying of similar material, the specification below refers to toy robotic devices, but the methods, processes, apparatus or devices may be utilized with other robot devices or robots.

The described subject matter may be utilized with any number of light emitters/transmitters and/or receivers/detectors. For ease of reading and simplicity, the description below utilizes infrared light emitters/transmitters and/or receivers/detectors

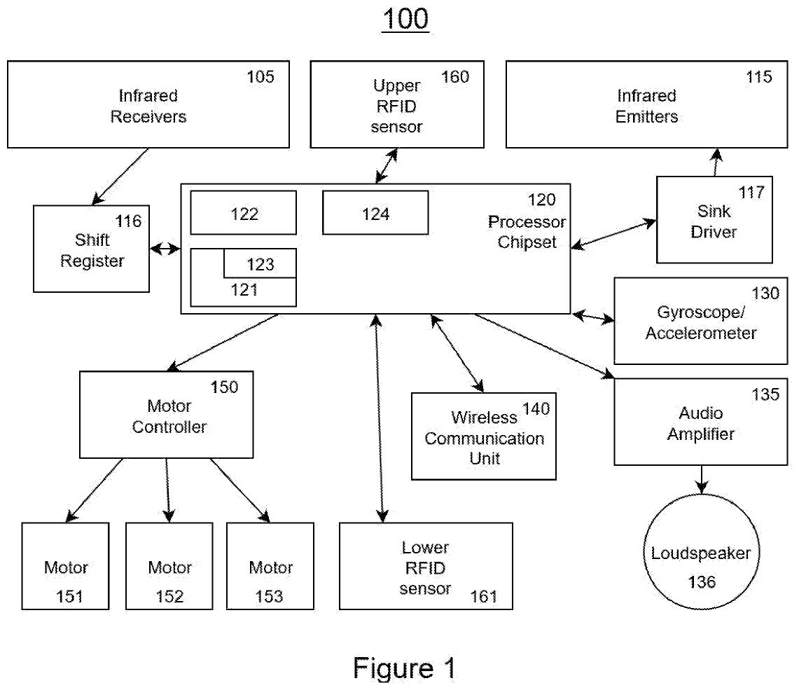

FIG. 1 illustrates a toy robotic device according to some embodiments. In some embodiments, the toy robotic device may be a server robot device or master robot device, or a may be a client robot device or slave robot device. In some embodiments, the toy robotic device 100 may comprise one or more processor chipsets 120 (which may be systems on a chip or an integrated circuit or other similar device). In some embodiments, the one or more processor chipsets 120 may comprise one or more volatile memory devices 122, one or more non-volatile memory devices 121 (PROM or Flash Memory or hard drive) and/or computer-readable instructions 123 executable by the one or more processors 124 to cause the toy robotic device to perform certain actions and/or operations. In some embodiments, computer-readable instructions (e.g., the software code) 123 may be stored in the one or more non-volatile memory devices 121 and loaded into the one or more volatile memory devices 122 for execution. In some embodiments, the one or more processors 124 may be processors, embedded processors, microprocessors, application specific integrated circuits, controllers and/or microcontrollers.

In some embodiments, the toy robotic device 100 may comprise a plurality of infrared receivers or detectors 105 and/or a plurality of infrared emitters or transmitters 115. In some embodiments, the computer-readable instructions executable by the one or more processors 124 may communicate with one or more infrared emitters 115 to cause the infrared emitters 115 to transmit or communicate infrared signals to other toy robotic devices. In some embodiments, the computer-readable instructions executable by the one or more processors 124 may cause commands, instructions and/or messages to be communicated to one or more sink drivers 117 and then for the one or more sink drivers 117 to communicate signals to the one or more infrared emitters 115 to cause the emitters to transmit or communicate infrared signals to other toy robotic devices.

In some embodiments, the plurality of infrared receivers 105 may receive infrared signals transmitted or communicated from infrared transmitters of other toy robotic devices. In some embodiments, computer-readable instructions executable by the one or more processors 124 may communicate with the infrared receivers 105 to have the received infrared signals transferred and analyzed to determine the content of the received infrared signals. In some embodiments, one or more shift registers 116 (which may correspond to the number of infrared receivers 105) may first receive the signals communicated from the plurality of infrared receivers 105 and then the one or more shift registers 116 may communicate the received infrared signals to the one or more processors 124 for analyzation. Although infrared transmitters and/or receivers are discussed above, the claimed subject matter (and/or the toy robotic devices) may work and/or be utilized with other light-based transmitters and/or receivers (plus other line-of-sight-based transmitters and/or receivers).

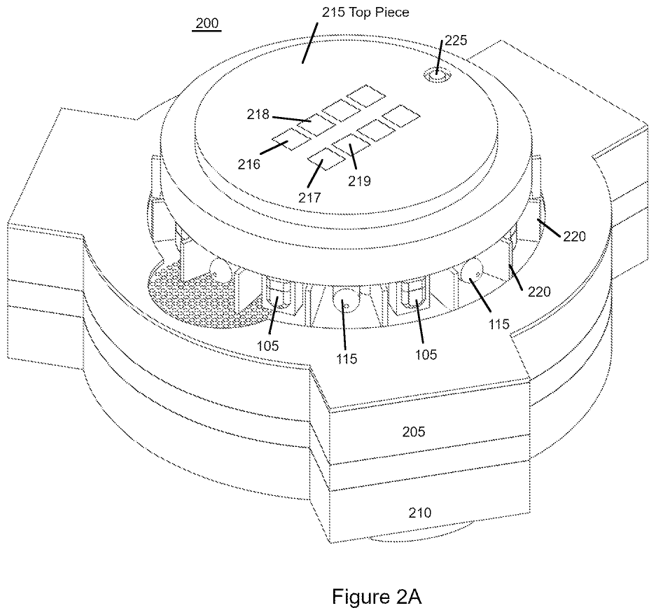

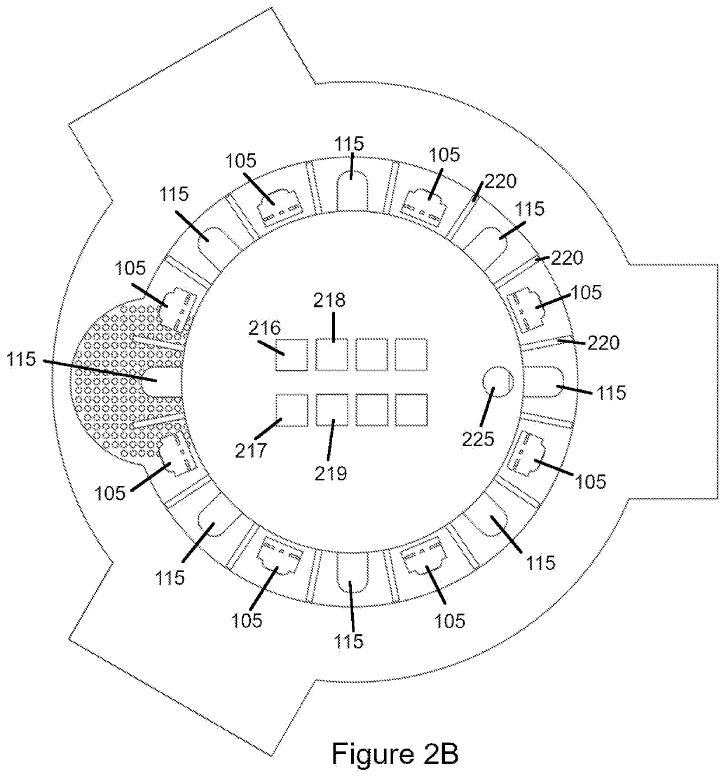

FIG. 2A illustrates a three-quarter view of a toy robotic device according to some embodiments. FIG. 2B illustrates a top view of a toy robotic device with a top plate removed in order to view emitters and/or receivers according to some embodiments. In some embodiments, the robot device 200 may comprise a top cover 205 and a bottom cover 210. In some embodiments, the top cover 205 may cover and/or surround a top portion of the toy robotic device and the bottom cover 210 may cover and/or surround a bottom portion of the toy robotic device. In some embodiments, the toy robot 200 may comprise eight infrared emitters 115 and/or eight infrared receivers 105. In some embodiments, the utilization of eight infrared emitters 115 and/or eight infrared receivers 105 allows for transmission of infrared signals in a 360-degree circle around the toy robot 200. This provides complete coverage from every direction and allows the toy robotic devices to be utilized in open areas and be able to respond and/or communicate with toy robotic devices coming from all directions in the environment. In some embodiments, as shown in FIG. 2B, the infrared emitters 115 and/or infrared receivers 105 are alternatively placed or positioned around a top cover 205 of the toy robotic device 200. In some embodiments, vertical dividers 220 are positioned between the infrared emitters 115 and/or the infrared receivers 105 to prevent infrared signals transmitted from the infrared emitters 115 to interfere with the infrared receivers 105 on the toy robot 200. In some embodiments, the vertical dividers 220 may be positioned also to keep infrared signals transmitted from infrared emitters 115 from interfering with each other (or the closest infrared transmitters). In some embodiments, the one or more vertical dividers 220 may be made of an opaque material or a material that does not allow light to pass through. In some embodiments, the toy robotic device 200 may comprise 16 vertical dividers 220. Although the number of emitters or receivers is eight and the number of dividers is 16 (as illustrated in FIG. 2B), any number of emitters and/or receivers (and dividers) may be utilized as long was the transmitters and/or receivers provides coverage for an entire area (e.g., 360 degrees) around the toy robotic device. This allows a toy robotic device to be able to communicate (e.g., both transmit and/or receive) with other toy robotic devices within an open space or open game play area. In some embodiments, the one or more infrared emitters and/or transmitters 115 may be placed and/or positioned on a top portion of a robotic toy device to allow for the infrared light and/or signal transmitted to travel a longer distance. Similarly, as mentioned previously, although the receivers and emitters are referred to as infrared receivers and/or emitters, receivers capturing other light spectrums and/or radiofrequency waves based on line-of-sight and emitters transmitting other light spectrums and/or radiofrequency waves may be utilized with the claimed subject matter to obtain the same results. In addition, as mentioned previously ultrasonic waves and/or magnetic waves may also be utilized.

In some embodiments, a toy robotic device 200 may comprise a plurality of lighting elements (which may be light emitting diodes). In FIGS. 2A and 2B, eight lighting elements are shown with four lighting elements numbered 216, 217, 218 and/or 219. Although FIGS. 2A and 2B illustrates eight lighting elements, any number of lighting elements may be utilized with the toy robotic device 200. In some embodiments, the lighting elements 216 217 218 and/or 219 may be illuminated to identify that certain actions are being performed. In some embodiments, as will be discussed later, action figures may be placed on a top surface of the top plate 215. In some embodiments, lighting elements 216 217 218 and/or 219 and light channels may be utilized to direct the light emitted from the lighting elements 216 217 218 and/or 219 to different parts of the figures through associated and/or coupled light channels to illustrate different actions being taken or performed. In some embodiments, for example, an illumination of lighting element 216 may illustrate a weapon being fired and thus the light emitted from lighting element 216 may be transferred to a hand of the action figure. In some embodiments, for example, an illumination of lighting element 217 may illustrate a laser being transmitted and thus the light emitted from lighting element 217 may be coupled and/or transferred to eyes of the figure. In some embodiments, the lighting of a plurality of lighting elements at the same time (e.g., lighting element 216 217 218 and 219) may indicate that an error condition or a warning condition is occurring with the toy robotic device (e.g., the toy robotic device 200 has been disabled or hit by a number of firing shots).

In some embodiments, a transparent cylindrical-shaped piece or assembly may be positioned and/or located around the toy robotic device and/or the action figure. In some embodiments, lighting elements in and/or below the transparent cylindrical-shaped piece or assembly may illuminate the transparent cylindrical-shaped piece or assembly to provide the illusion of a shield around the action figure and/or toy robotic device (which may or may not surround an entirety of the toy robotic device and/or action figure). In some embodiments, a toy robotic device and/or an action figure may include lighting elements positioned and/or installed in a center of either the toy robotic device and/or action figure and these center-installed lighting elements may be illuminated to represent and/or look like an internal power source and/or power reactor glowing inside the toy robotic device and/or action figure. In some embodiments, other areas of the toy robotic device and/or action figure may include lighting elements and when these lighting elements in the other areas are illuminated, the illumination may represent either the activation of specific abilities of the toy robotic device (and/or action figure) and/or damage to certain areas of the toy robotic device and/or action figure. In some embodiments, lighting elements in different areas of the toy robotic device and/or action figure may be illuminated in a sequence to provide an illusion and/or representation of movement and/or animation in the toy robotic device and/or action figure.

In some embodiments, the toy robotic device may comprise one or more gyroscopes and/or one or more accelerometers 130 to monitor and/or measurement acceleration and/or direction of the toy robot device 100. In some embodiments, the one or more gyroscopes 130 may generate measurements and/or parameters to identify a direction that the toy robotic device 100 is facing. In some embodiments, the gyroscope measurements and/or parameters may be utilized by the toy robotic device to move the toy robotic device in a direction relative and/or related to the direction the toy robotic device may be facing. In other words, in some embodiments, for example, the gyroscope's measurements and/or parameters may be utilized so that moving left from a player or operator's point of view (at a controller device or mobile communication device) is translated correctly into a movement to the left in the toy robotic device. In some embodiments, the one or more gyroscopes 130 may capture measurements and/or parameters representative and/or indicative of a level (e.g., a height) on which a toy robotic device is positioned and/or location where the toy robotic device is located. In some embodiments, these gyroscope parameters and/or measurements may be utilized to determine and/or identify if the toy robotic device has fallen over and/or is located on a sloped surface. In some embodiments, the one or more accelerometers 130 may capture and/or measure a speed and/or velocity measurements and/or parameters of the toy robotic device. In some embodiments, the accelerometer measurements and/or parameters may be utilized to determine a speed a toy robotic device is moving. In some embodiments, the accelerometer measurements and/or parameters may be utilized to determine if the toy robotic device has collided with another toy robotic device and/or an object (or vice versa). In some embodiments, the one or more gyroscopes and/or accelerometers 130 may be combined to allow tracking of movement of the toy robotic device and/or may also be utilized to identify a position or location of the toy robotic device.

In some embodiments, the toy robotic deice 100 may comprise an audio amplifier 135 and a speaker 136 to receive audio signals and reproduce audio signals on the loudspeaker 136. In some embodiments, audio signals may be stored in one or more memory devices 122 before being transferred to the audio amplifier 135 and/or speaker 136. In some embodiments, audio signals may be transferred to the toy robotic device from a control device, a wireless communication device and/or a server toy robotic device and then transferred to the audio amplifier and/or speaker.

In some embodiments, the toy robotic device 100 may comprise one or more wireless communication units or transceivers 140, as was discussed above. In some embodiments, the wireless communication transceivers 140 may be WiFi or other 802.11 wireless communication transceivers. In some embodiments, the wireless communication transceivers 140 may be personal area network (PAN) transceivers such as BlueTooth and/or Zigbee transceivers. In some embodiments, the wireless communication transceiver 140 may be a cellular communication transceiver such as a transceiver operating according to 3G, 4G, and/or 5G communication protocols. In some embodiments, other communication transceivers may be utilized.

In some embodiments, the toy robot device 100 may comprise one or more motor controllers 150, and three motors or motor assemblies 151, 152 and/or 153. In some embodiments, one motor controller 150 may interface with all motors (or motor assemblies) 151, 152, and/or 153. In alternative embodiments, each motor or motor assembly may have its own motor controller. In some embodiments, the toy robotic device 100 may comprise three sets of wheels and the three sets of wheels may allow the toy robot device 100 to move in any direction. In other words, the toy robot device 100 may have omnidirectional functionality. In some embodiments, these wheels may be referred to as omni wheels and/or poly wheels. In some embodiments, if all of the wheels or wheel assemblies all turn clockwise (or a same direction) at once, the toy robotic device 100 may spin in the clockwise (or specified) direction on a spot or point where a toy robotic device is located and/or positioned. In some embodiments, if two wheels or wheel assemblies turn and/or operate in opposite directions, while a third wheel assembly remains stationary, the toy robotic device may move in a direction of an axis that is the average of the angles of the two wheels or wheel assemblies that are moving. Thus, by having the motor controllers 150 and/or motors 151 152 and 153 vary a direction and/or power applied to the different wheels or wheel assemblies independently, the toy robotic device may be moved and/or rotated in any direction desired by the user and/or operator.

In some embodiments, the toy robotic device 100 may comprise a lower RFID sensor and/or reader 161 and an upper RFID sensor and/or reader 160. In some embodiments, the lower RFID sensor and/or reader 161 may communicate with and/or pair with a RFID transmitter or tag on a mounting plate or other positioning plate in an area where a toy robotic device is located. In some embodiments, the positioning plate may provide a starting point for a toy robotic device 100 in an action (or game). In some embodiments, the upper RFID sensor and/or reader 160 may communicate with an RFID transmitter and/or tag on a toy figure in order to identify the toy or action figure and/or character that is being placed on top of and/or mounted on the toy robotic device. Although the specification herein mentions an RFID reader and/or transmitter, other devices may be utilized for identification such as QR Codes and/or bar codes being placed on action figures and/or mounting plates and then the toy robotic device may utilize a bar code reader and/or QR code reader to capture and/or analyzed the bar code or QR code.

In some embodiments, a toy robotic device 100 may have a height ranging from 35 millimeters to 75 millimeters. In some embodiments, the toy robotic device 100 may have a length ranging from 100 millimeters to 150 millimeters. In some embodiments, the toy robotic device 100 may have a width ranging from 100 millimeters to 150 millimeters. These are only representative height, width and/or length measurements and smaller measurements for each of the dimensions may be utilized. Different factors may be evaluated in determining dimensions of the toy robotic device 100 such as hardware configuration, environment toy robotic device being utilized in (e.g., indoor versus outdoor environments), how quickly toy robotic devices may move and/or durability of the toy robotic device. The systems, devices, apparatus, methods and/or processes described herein may be utilized in larger toy robotic devices as well as larger robotic devices or robots. In other words, words like toy should not be utilized to constrain the limits of the subject matter of the invention (it is only utilized to describe one potential configuration and for ease of use in describing the invention—rather than having multiple repetitive descriptions for different types of robotic devices or robots).

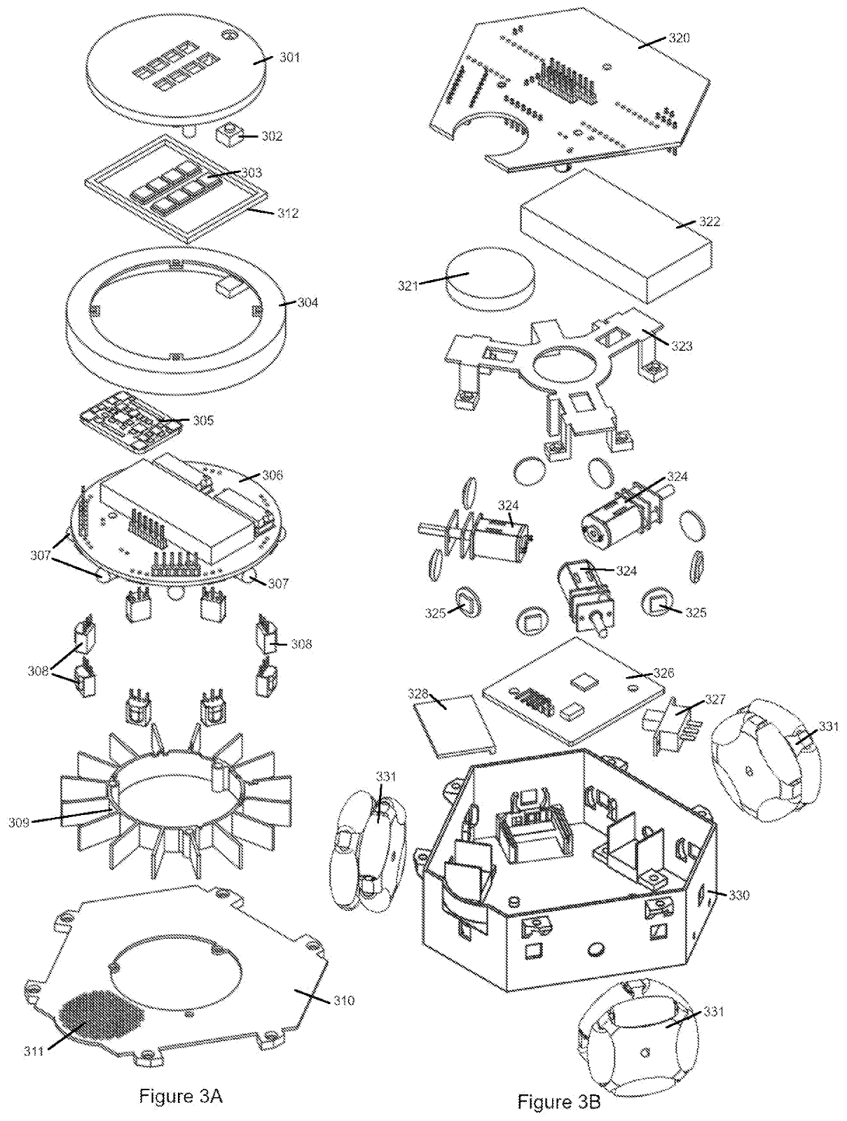

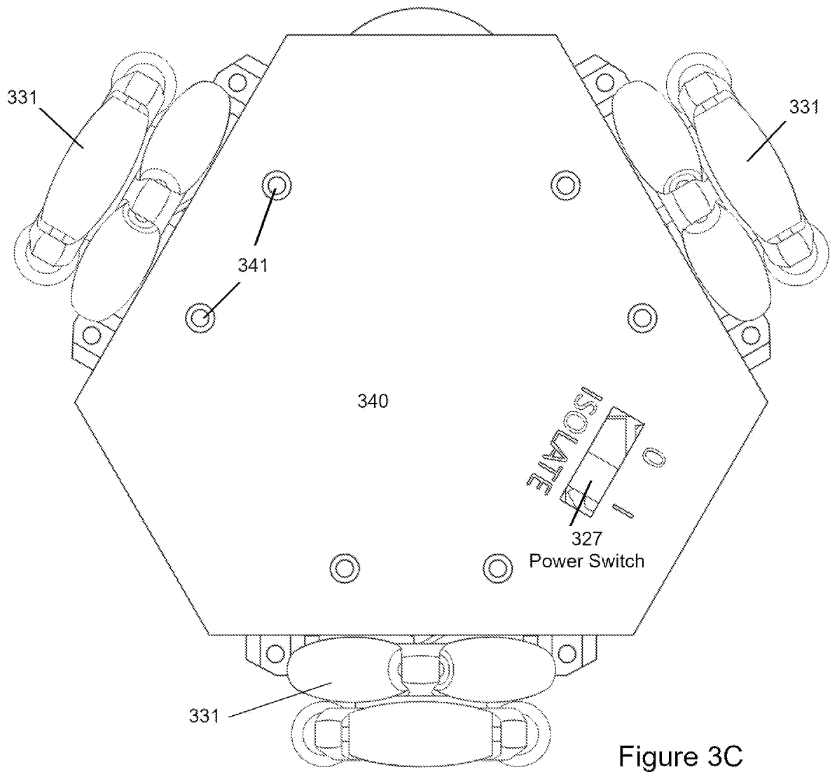

FIG. 3A illustrates an exploded view of a top portion of a toy robotic device according to some embodiments. FIG. 3B illustrates an exploded view of a bottom portion of a toy robotic device according to some embodiments. The left-hand side illustrates an exploded view of a top portion of a toy robotic device while the right-hand side illustrates an exploded view of a bottom portion of a toy robotic device. In some embodiments, a top portion of a toy robotic device may comprise a plastic lid 301, a selection button 302, a plurality of lighting elements or assemblies 303, which may be installed on a plate or holder, and/or a plastic shroud 304 In some embodiments, a top portion of a toy robotic device may comprise one or more gyroscopes and/or one or more accelerometers 305, and/or a top circuit board 306. In some embodiments, a top portion of the toy robotic device may further comprise a radio frequency identifier (RFID) reader 312. In some embodiments, a top circuit board 306 may comprise one or more processors, one or wireless communication transceivers, one or more memory devices and/or computer-readable instructions stored in the one or more memory devices (as discussed above with respect to FIG. 1). In some embodiments, the top circuit board may comprise a system-on-a-chip and/or a processor chipset, which may include the one or more processors, the one or more wireless transceivers, the one or more memory devices and/or the computer-readable instructions. In some embodiments, the upper circuit board 306 may also comprise a plurality of emitters 307 (e.g., infrared emitters), which may be installed on a bottom side of the upper or top circuit board 306. In some embodiments, the top circuit board 306 may further comprise a plurality of receivers 308 (e.g., infrared receivers), a separator assembly 309, and/or a plastic lid for a bottom portion of a toy robotic assembly 310. In some embodiments, the plastic lid 310 may comprise a speaker grill 311. In some embodiments, the one or more lighting elements 303 may fit into or be positioned into associated holes or openings in the plastic lid 301. In some embodiments, the selection button 302 may fit into or be positioned into an associated opening in the plastic lid and may control different functions of the toy robotic device (e.g., selecting the toy robotic device as the server toy robotic device, and/or selecting a specific mode for the toy robotic device). In some embodiments, a rectangle around a plate on which the lighting elements may be resident or installed may represent an RFID aerial 312 which allows the reading of an RFID chip or transmitter on, for example, an action figure, to determine what characteristics, mannerisms or parameters should be utilized with the coupled action figure. In some embodiments, tabs on an underside of the plastic lid may fit into openings into receiving clips in the plastic shroud 304 to secure the plastic lid 301 and lighting elements 303. In some embodiments, the one or more gyroscopes 305 may be on a separate printed circuit board and/or the printed circuit board may also include one or more accelerometers (not shown). In some embodiments, the upper circuit board 306 may have a SOC installed on a top surface while the plurality of emitters 307 may be installed or positioned on a bottom surface. In some embodiments, the plurality of receivers 308 may be connected to the top or upper circuit board 306 via associated or corresponding holes in the top circuit board 306 (where connector pins of the plurality of receivers are placed). In some embodiments, the plastic separator 309 may separate the plurality of emitters 307 from the plurality of receivers 308 and prevent interference in receptance of signals by the plurality of receivers 308. In some embodiments, the plastic separator may have a circular opening in its center and/or middle. In some embodiments, a plastic separator 309 may have connection assemblies where fasteners or connectors may be inserted in order to connect or attach to the plastic lid 310. In some embodiments, the plastic lid 310 may had an opening in its middle to allow for pins and/or electrical connectors to attach to components and/or assemblies of the upper or top circuit board 306 (e.g., the SOC, etc.). The placement of components is one embodiment of how this section or portions of the toy robotic device may be configured and other configurations and/or embodiments of the same and similar components may also be utilized.

FIG. 3B illustrates a bottom portion of the toy robotic device according to embodiments. In some embodiments, the bottom portion of the toy robotic device comprises a lower circuit board 320, one or more speaker assemblies 321, one or more power sources 322 (e.g., rechargeable or regular batteries), a plurality of plastic motor holders 323 and/or a plurality of motors or motor assemblies 324. In some embodiments, the bottom portion of the toy robotic device may also comprise a plurality of status lighting elements or LEDs 325. In some embodiments, the bottom portion of the toy robotic device may further comprise an RFID reader assembly or PCB 326, one or more power switches or assemblies 327 and/or a battery charging assembly 328. In some embodiments, the lower portion or section of the toy robotic device may further comprise a body assembly 330 (e.g., plastic body), and/or a plurality of wheel assemblies 331. In some embodiments, a bottom surface of the lower printed circuit board 320 may comprise a plurality of pins and/or electrical connectors to which the power source 322 may attach. In some embodiments, the lower printed circuit board 320 may comprise a plurality of motor controllers, one or more audio amplifiers and/or one of more shift registers. In some embodiments, the lower printed circuit board may include an opening into which the one or more speaker assemblies 321 may be installed or positioned. In some embodiments, a portion of the lower printed circuit board 320 may also rest or be positioned on a top surface of a plastic motor holder 323. In some embodiments, the plurality of motors or motor assemblies 324 may be located, positioned and/or installed in associated and/or corresponding openings in the plastic motor holder 323. In some embodiments, the power switch 327 may turn on or off the toy robotic device 300. In some embodiments, the body 330 of the bottom toy robotic device may also include holders for the plurality of motor assemblies 324 and may allow shaft of the plurality of motor assemblies to exit the body 330 via openings or holes in the sides of the body 330. In some embodiments, the shafts of the plurality of motor assemblies 324 extend at a length to be inserted into a corresponding opening in the one or more wheel assemblies 331. In some embodiments, these shafts connect the one or more wheel assemblies 331 to the body 330 of the bottom portion of the toy robotic device. In some embodiments, the plurality of status lighting elements 325 are also attached to the body 330 and the status lighting elements 325 may be visible to users and/or operators via holes or opening in the sides of the body 330 of the toy robotic device. In some embodiments, the body 330 of the bottom portion of the toy robotic device may have ledges with openings to allow connection tabs of the plastic lid 310 of the upper portion of the toy robotic to connect or attach to the bottom portion of the toy robotic device via fasteners or connectors. In some embodiments, the toy robotic device may comprise nine status lighting elements although other numbers of status lighting elements may be utilized.

FIG. 3C illustrates a bottom view of a toy robotic device according to some embodiments. In some embodiments, a bottom surface 340 of the plastic toy robotic body 330 may have a plurality of motor connectors or openings 341 to connect or attach the plurality of motor assemblies 324 to the plastic toy robotic body 330 (or to connect the holders on a floor of the plastic toy robotic body to the plastic toy robotic body). In some embodiments, the plurality of wheel assemblies 331 are connect to a number of sides of the plastic toy robotic body 330. As illustrated in FIG. 3C, the plastic toy robotic body 330 may have a hexagonal shape. In some embodiments, the plurality of wheel assemblies 331 may be connected to three sides of the six sides of the plastic toy robotic body 330. In some embodiments, the power switch or power switch assembly 327 may be visible and extend from a bottom surface 340 of the plastic toy robotic body 330.

In some embodiments, a toy robotic device or a base station device may utilize a plurality of infrared emitters to transmit, send or communicate messages to other robotic devices. In order to address shorter or longer distances between toy robotic devices and/or base stations, a brightness of an infrared signal being emitted or transmitted may be varied with a brighter infrared signal being able to be received or detected at longer distances. In some embodiments, a toy robotic device and/or a base station device may also comprise a plurality of infrared detectors and/or receivers. In some embodiments, the infrared detectors and/or receivers may be utilized to detect and/or not detect a brightness of a transmitted or emitted infrared signal in order to identify or calculate how far one toy robotic device is from another toy robotic device and/or base station device. In some embodiments, the toy robotic device may comprise a time-of-flight sensor. In some embodiments, the time-of-flight sensor may calculate a distance from an emitter (e.g., an infrared or other light-based emitter) to the toy robotic device including the time-of-flight sensor. This is a slightly more expensive solution but provides a measurement of distance between the toy robotic device transmitting the infrared or other light-based signal and the toy robotic device receiving the infrared or other light-based signal and is able to provide more precise location information.

In some embodiments, the toy robotic devices and/or base station devices may also control which infrared emitters may transmit and/or emit infrared signals. In some embodiments, for example, if eight infrared emitters are arranged in a horizontal circle around a robotic device and/or a base station device, a message may be sent from each of the eight infrared emitters in turn individually (e.g., in a sequential fashion), knowing which other robotic devices detected the message may give an indication of what angle and/or position the other toy robotic devices are located in relative to the toy robot device emitting the message. In some embodiments, the infrared signals may be transmitted or emitted from the infrared transmitters at the same time. Similarly, in some embodiments, a toy robotic device's receivers' detection of the infrared message or signal may provide the toy robotic device with additional information. In some embodiments, for example, if eight infrared receivers are arranged in a horizontal circle around the toy robotic device, knowing which infrared receivers detected an infrared signal or message may provide the toy robotic device with an indication of what direction or position the infrared message came from or was transmitted from (and thus the position of the transmitting toy robotic device).

In some embodiments, the toy robotic devices or base station devices may transmit, communicate or sent different types of infrared messages or signals. In some embodiments, the robotic toy devices and/or base station devices may transmit an infrared pulse or infrared pulse signal. In some embodiments, the toy robotic devices or base station devices may create the infrared pulse or infrared pulse signal by turning on and/or off the infrared emitter(s) for specified lengths of times (e.g., turning on for a period of time and turning off for a period of time). Examples uses of such pulses including a “waiting” pulse identifying a different infrared signal is about to be transmitted. In some embodiments, a length of a pulse may be modified.

In some embodiments, the toy robotic devices or base station devices may transmit, communicate or send an infrared digital signal (IDS). In some embodiments, the toy robotic device or base station device may create an IDS by emitting two separate short infrared pulses with a length of time (or gap time) representing a 0 or a 1. For example, a one microsecond gap time may represent a 1 and a two microsecond gap time may represent a 0. In this manner, the toy robotic device or base station device may generate IDS with chains of pulses and gaps that store and/or represent information, parameters and/or instructions that may form a binary string. In some embodiments, the binary string of chains of pulses and gaps may form and/or generate messages between toy robotic devices (such as identifying when different times or time slots in which different toy robotic device may fire shots towards other toy robotic devices and/or the results of the firing shots). In some embodiments, the IDS signals may allow messages to be transmitted or sent between toy robotic devices and base station devices.

In some embodiments, other devices besides toy robotic devices and/or base station devices may be used by players or users to transmit commands to the toy robotic devices that the controllers are associated with and/or controlling. In some embodiments, the control devices allow users or operators to interface with and/or interact with the toy robotic devices and engage in games. In some embodiments, these may be referred to as controllers, game controllers and/or controller devices. In some embodiments, controllers or game controllers may include, but are not limited to, mobile communication devices (e.g., mobile phones, PDAs), wireless joypads (e.g. PS4 Dual Shock, XBox controller), and/or tablets (e.g. iPad and/or Galaxy tablets). In some embodiments, a game controller or game device may display information, parameters and/or status of a toy robotic device being controlled (e.g. on a phone screen, or using lights on a joypad). In some embodiments, the information, parameters and/or status being displayed may be related to a game being played for the purposes of keeping the player informed about the state of the game and the state of the robotic device that the player or user is controlling. In some embodiments, these controllers, game controllers or controller devices may have computer-readable instructions stored in one or more memory devices that are executable by one or more processors in order to communicate with the toy robotic devices.

In some embodiments, for any game play scenario between the robotic toy devices, a server toy robotic device may be needed or required. This may also be true with other utilizations of the claimed subject matter besides games where one robotic device may need to be a master robotic device and/or a server robotic device when engaging with other toy robotic devices. In some embodiments, this is because the server robotic toy device may host and/or initiate the wireless network (e.g., the WiFi (802.11), cellular and/or PAN network) that may connect the toy robotic devices, controllers and/or base station devices that are playing the game and/or that form the established wireless communication network. In some embodiments, the server toy robotic device may also host and/or execute the computer-readable instructions necessary for playing and/or executing the game. In other words, the game-related computer-readable instructions executable by the one or more processors of the server robotic toy device may be stored in one or more memory devices of the server robotic toy device. In such embodiments, the server robotic toy device may require more memory devices than a client toy robotic device in order to store and/or execute the server-related computer-readable instructions.

In some embodiments, for instance in a shooting game, a server robotic toy device may receive and/or process inputs, parameters, commands and/or instructions received from any controller devices or controllers. In some embodiments, for example, the robotic server toy device may receive inputs, parameters, commands and/or instructions from a wireless joypad or a mobile communication device (e.g., the game controllers) connected to the established wireless network. In some embodiments, the game-related computer-readable instructions may be accessed and/or retrieved from the one or more memory devices and may be executable by the one or more processors of the server toy robotic device to process the received inputs from the controllers according to game rules and logic (which may be embedded in the computer-readable instructions or software). In some embodiments, based at least in part on the processing of the received inputs, the server toy robotic device may determine or decide if a given robotic device needs to move to a new position, flash the toy robotic device lighting elements, have the toy robotic device fire an infrared “shot” (or firing infrared IDS) and/or perform other actions. In some embodiments, the server robotic computing device may determine the upcoming and/or future actions based on executing the computer-readable instructions which incorporated the game logic and rules. In some embodiments, the server robotic computing device may communicate these determined actions to the associated or corresponding toy robotic devices via the established wireless communication network. In some embodiments, the software being executed by the one or more processors of the server toy robotic devices may also maintain parameters and measurements related to the different toy robotic device's health, utilization of shields, ammunition counts, firing rate, etc. In some embodiments, the parameters and/or measurements for the different toy robotic devices may be stored in one or more memory devices of the server toy robotic device (e.g., in, for example, a database). In some embodiments, the server toy robotic device may transmit or send statistics, parameters and/or measurements to controller devices associated with the different toy robotic devices via the established wireless communication network. In some embodiments, a display on a monitor, display or screen of the controller device may display this information for the user and/or operator to see and/or act upon.

In some embodiments, the server toy robotic device may be one of the toy robotic devices playing the game. In some embodiments, the server toy robotic device may be a base station device that performs the functions listed above for the server toy robotic device but is not engaged in the game playing. In some embodiments, where the server toy robotic device is one of the connected toy robotic devices (and is engaged in game play), when there is a wireless message being sent to the toy robotic devices engaged in the game play over the established wireless communication network, the server toy robotic device may transmit the message over the established wireless network and also may simulate receiving the message. This is because there is no point to transmit or send the message wirelessly to itself and take up time and resources on the server toy robotic device.

In some embodiments, if a toy robotic device is not a server toy robotic device, the toy robotic device may connect to the server toy robotic device via the established wireless communication network as a client toy robotic device. In some embodiments, the client toy robotic device may act on any commands or messages transmitted or sent to the client toy robotic device by the server toy robotic device. In some embodiments, the command from the server robotic toy device may include, but is not limited to, a command, instructions, message or signal to (1) display a certain light pattern using the client toy robotic device's lighting elements (e.g., LEDs), (2) move the client toy robotic device in a certain direction, (3) the client toy robotic device sending or transmitting a value or measurement from a gyroscope or accelerometer to the server toy robotic device, and/or (4) the client toy robotic device playing a sound effect on the client toy robotic device's speaker.

A toy robotic device may be a server toy robotic device or a client toy robotic device. In some embodiments, the server toy robotic device and the one or more client toy robotic devices may comprise the same or similar hardware and/or software. In some embodiments, the server toy robotic device may have different and/or additional software as compared to the one or more client toy robotic devices. In some embodiments, the server toy robotic device and the one or more client toy robotic devices may have the same software; however, the server toy robotic device may be selected as the server toy robotic device and then may access and/or execute the server-related software, while the one or more client toy robotic devices do not access and/or executed the server-related software.

In some embodiments, a base station or base station device may comprise the same or similar components to a toy robotic device (e.g., either a client toy robotic device or a server robotic device), but may not include one or more motor controllers, one or more motor assemblies, and/or one or more wheel assemblies (in addition to other connectors, fasteners and/or components associated therewith). In some embodiments, this is because the base station may not require movement. In some embodiments, the base station may provide a reference point for other toy robotic devices (e.g., it may be a starting location, an ending location and/or a reference location). In some embodiments, the base station may comprise the functionality of the server toy robotic device, but may not participate in playing the game because it may not move like other toy robotic devices may move. In some embodiments, the base station may comprise the functionality of a client toy robotic device (e.g., such as a non-movable tower or turret where guns or shots are being fired, but that does not move).

In some embodiments, after start-up or power on, a toy robotic device may first initialize its assemblies and/or components, e.g., accelerometers, gyroscopes, sensors, and/or one or more processors (along with other components). In some embodiments, the toy robotic device may look or search for infrared signals utilizing its infrared sensors or receivers. In some embodiments, a toy robotic device may receive a command to become a server robotic device. In some embodiments, the robotic toy device may receive the server robotic device command by 1) receiving a command message wirelessly via a wireless network to which the toy robotic device is connected; 2) becoming a server robotic device immediately after the server robotic device is powered on (e.g., command instruction or message may be stored in a non-volatile memory device which is executable by the one or more processors of the toy robotic device upon initialization or startup of the toy robotic device; and/or 3) a physical button or switch on the robotic toy device may be pressed, activated or turned on, which in turn may cause the robotic toy device to become a server toy robotic device.

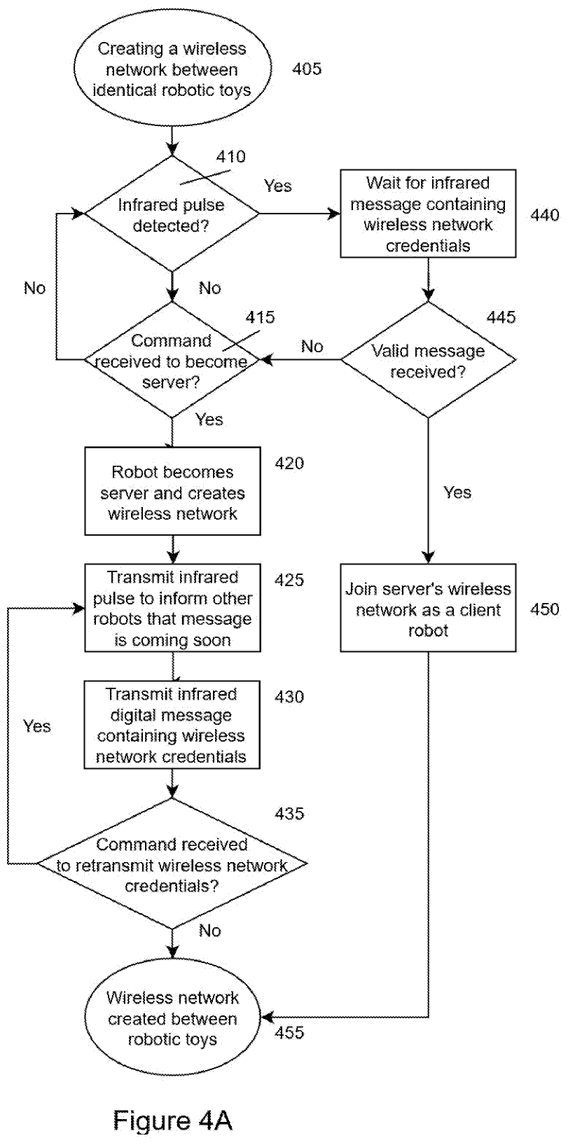

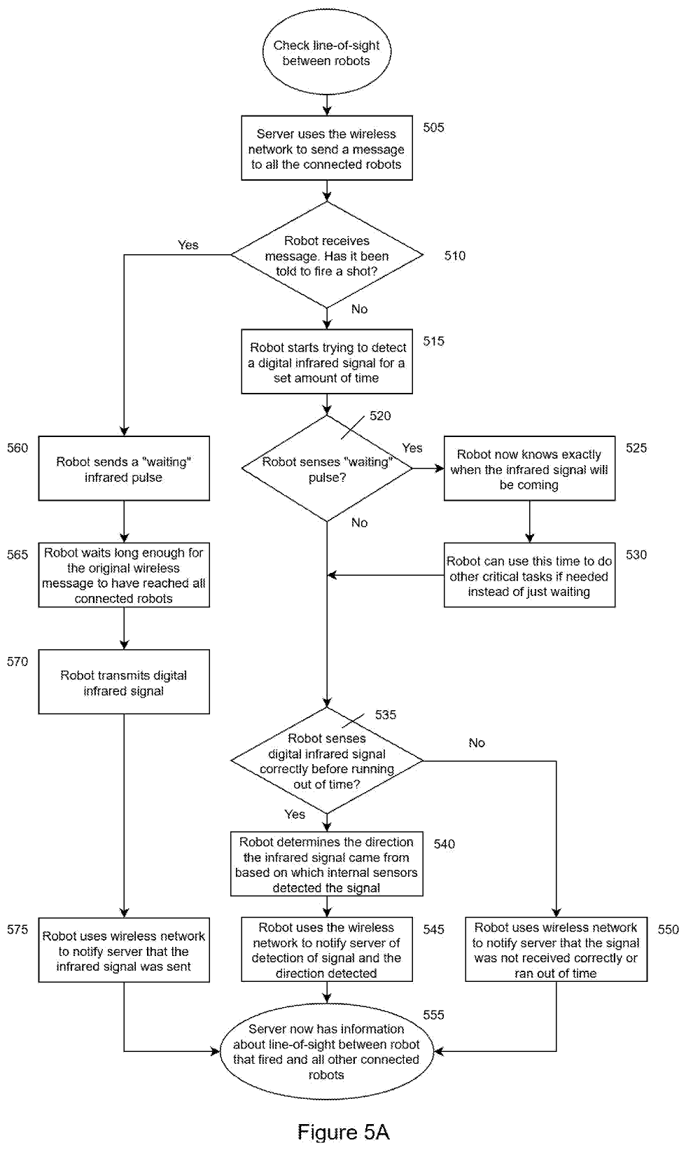

FIG. 4A illustrates a method for establishing a wireless network between two or more robotic toy devices. The establishing of the wireless communication network is important in order for any communication to take place between the server toy robotic devices and/or the client toy robotic devices. In this embodiment, the wireless network established herein only includes the toy robotic devices playing and/or engaging in the game or coordinated task. In some embodiments, in step 410, computer-readable instructions executable by one or more processors of the toy robotic devices may have infrared receivers activated to determine if infrared signals (e.g., an infrared pulse) are being transmitted or communicated from other robotic toy devices, base stations and/or controller devices. In some embodiments, if no infrared signals (e.g., an infrared pulse) are received, computer-readable instructions executable by one or more processors of the toy robotic devices may determine if a command, instruction and/or message is received 415 to become a server toy robotic device. In some embodiments, if no command is received, then the toy robotic device may continue to wait 410 to see if an infrared pulse is detected or if a command to be a server device is received.

In some embodiments, if the command, instruction and/or message is received to become a server toy robotic device, computer-readable instructions executable by one or more processors of the receiving toy robotic device may cause the toy robotic device to become and/or configure itself as the server toy robotic device and to create 420 a wireless network for other toy robotic devices. In some embodiments, this wireless network may now be referred to as an established wireless network, a created wireless network, or a wireless communication network. In some embodiments, the server robotic toy device may transmit or communicate an infrared pulse 425 to inform other toy robotic devices that a message is coming soon or within a specific timeframe. In some embodiments, the server robotic toy device may transmit an infrared pulse from all infrared emitters at one time to indicate that a network is being created. In some embodiments, the server robotic toy device may transmit an infrared pulse at maximum brightness to indicate that a network is being created. In some embodiments, the server robotic device may transmit or communicate an infrared digital message (IDS) containing wireless network credentials 430. In some embodiments, the server toy robotic device may wait a short timeframe after a transmission of the infrared pulse and may then transmit, send or communicate an infrared digital signal or infrared digital message. In some embodiments, the server robotic device may transmit, send or communicate the infrared digital signal or infrared digital message at a maximum brightness from all of the infrared emitters or transmitters. In some embodiments, during establishment of the wireless network, the infrared digital signal or infrared digital message may include the name of the wireless network, a password (if needed), and/or a checksum to ensure that a corrupt signal (not having the checksum) can be ignored. In some embodiments, the server robotic toy device may transmit, send or communicate the infrared digital signal or infrared digital message multiple times in succession (or after a period of time) to eliminate, mitigate or reduce possible infrared signal interference from other infrared signals emitted or transmitted in the same location or same area. In some embodiments, if a robotic toy device receives the infrared digital message or signal, the robotic toy device may join the wireless network (to create an established wireless network). In some embodiments, the toy robotic device may communicate the name and/or password if needed to join the wireless network. In some embodiments, some of the robotic devices may not receive the infrared digital message and may request that the server robotic toy device retransmits the wireless network credentials.

In some embodiments, the server robotic toy device may receive the command, message or instruction to retransmit the wireless network credentials 435. In this case, the process will return to step 425. In some embodiments, if there is no command received to retransmit the wireless network credentials at the server robotic toy device, then the server robotic toy device may continue to establish 450 a wireless network between the server robotic toy device and other responding client toy devices.

In some embodiments, if an infrared pulse is detected (which means the toy robotic device is not receiving the command to be a server toy robotic device), then a robotic toy device may wait 440 for an infrared message including wireless network credentials. In some embodiments, a robotic toy device may wait a specified time. In some embodiments, if a valid message is received 445 including the wireless network credentials, then the robotic toy device that received the valid wireless network credentials may join the server robotic device's wireless network as a client robotic device 450. In some embodiments, if a valid message is not received, then the toy robotic device may see if a command to become a server is received 415 and if not, then may wait to detect an infrared pulse 410 In some embodiments, after all of the responding client robotic toy devices have responded, the wireless network between the server robotic toy device and the other responding client toy devices may be finally established 455. In this embodiment, the infrared line-of-sight network is utilized to establish the wireless communication network.

Using light emitters and/or detectors with toy robotic devices and/or in a game system may create some issues. In some embodiments, the different devices may need to have line-of-sight with each other and/or with other stationary devices. Utilizing infrared emitters and/or infrared detectors is a well-established communication technology and/or technique and is utilized in laser tag systems or games. However, when there are multiple devices involved (e.g., a plurality of toy robotic devices) problems occur when line-of-sight checks or transmissions are performed with the multiple devices and/or if these checks or transmissions are all occurring at the same time.

In some embodiments, for example, with a robotic toy device shooting game, where more than two toy robotic devices (under control of users or players) may be trying to transmit shots (e.g., infrared digital signals or pulses at each other), interference between the transmitted signals from the two or more toy robotic devices may occur. Thus, in some embodiments, if two or more robotic toy devices fire shots or shoot infrared signals at the same time, the infrared light from the two or more robotic toy device's emitters may be mixed and thus any toy robotic device that receives the transmitted mixed infrared signal may not know which toy robotic device transmitted the infrared signal.

In some embodiments, for example, in order to address the issue of interference and/or mixed signals (at different wavelengths such as an infrared wavelength), the server toy robotic device may schedule timeslots for toy robotic devices to utilize in firing shots and/or transmitting specific wavelength signals. While the discussion describes utilizing infrared signals, the below-described process may be implemented utilizing other line-of-sight signals besides infrared signals. In some embodiments, another wireless communication network, (e.g., a network utilizing wireless communications such as WiFi, 802.11, cellular and/or PAN signals), may be utilized to synchronize a time slot for each toy robotic device in the established wireless communication network to fire (or emit) a specific wavelength of light (e.g., infrared digital signal or infrared pulse), as well as to perform other actions. In some embodiments, the other toy robotic devices in the established wireless communication network may be wirelessly synchronized to try and detect the transmitted infrared signal transmitted from the scheduled toy robotic device. In other words, the other toy robotic device may also know the timeslots in which the other specific toy robotic devices are scheduled to transmit or emit their infrared firing shots and/or other infrared digital signals (e.g., the other toy robotic devices assigned timeslots). In some embodiments, accordingly, any toy robotic device that detects or receives the transmitted or emitted infrared firing shot (or other infrared signal) in that timeslot may know which toy robotic device transmitted or emitted the firing shot (or other infrared signal). In some embodiments, a transmitted signal may also be pulsed on and off to form and/or generate an infrared digital signal (IDS) (as discussed above), if needed to allow each infrared firing signal to be identified and/or verified. In some embodiments, wireless communication signals between the server toy robotic device and/or the client toy robotic devices may inform or provide information to each client robotic toy device what type of infrared digital signal is about to be transmitted. According to some embodiments, thus, as a client robotic device detects an infrared digital signal, the client robotic device may then check and/or match the received or detected IDS against what was expected to be received in order to verify the received or detected IDS is not being transmitted from another infrared transmitting source or is background interference.

In some embodiments, the method described above and below may be utilized by players or users utilizing toy robotic devices in, for example, a shooting game and assumes that all toy robotic devices may be connected to the same established wireless communication network (the creation of which is described above with respect to FIG. 4A). In some embodiments, the players may play the shooting game utilizing connected controllers or controller devices, as have been described above, to communicate desired actions of the toy robotic devices. In some embodiments, one of the desired actions may be the transmission of an infrared digital signal (IDS) and/or an infrared pulse. In some embodiments, a server toy robotic device (which could be one of the toy robotic devices or a base station) may manage a list of the toy robotic device's shot firing requests. In some embodiments, two or more shots of a same type and from a same toy robotic device may be bundled together into a single shot IDS. In some embodiments, the single shot IDS may represent multiple shots to mitigate long queues in the server toy robotic device of shots signals waiting to be processed.

In some embodiments, there is a physical limit to how fast the shots may be fired (e.g., either how fast a server toy robotic device can fire the shots or how fast the client toy robotic devices can request the shots or emit the pulses). In other words, transmission and/or reception of wireless signals and/or infrared signals takes a finite time. This total finite time may be slower than a speed of firing that a game being played dictates for a given situation and/or set of circumstances. Due to the physical limit, a server toy robotic device may determine which toy robotic device may be allocated a time slot for firing (e.g., be able to emit or fire shot IDS) based on a number of factors and/or parameters. In some embodiments, these factors and/or parameters may include, but are not limited to: 1) which player or toy robotic device has waited the longest to fire or emit a shot IDS; 2) which player or toy robotic device has the most firing shots or requests waiting in the queue of the server toy robotic device; and/or 3) which player or toy robotic device has had the longest time since the payer has had a shot fired or shot IDS emitted. As discussed previously, although referred to above as a shot IDS, the signal may be as simple as a single infrared pulse. In other embodiments, the shot could be a series of pulses and gaps that represent a binary sequence that can contain whatever information a given application needs or request. In some embodiments, after a server robotic toy device has decided which shot or shot IDS is to be fired or emitted, one of the methods and processes described below may be utilized. In some embodiments, the determination as to which process to be utilized below may be based on the following factors or parameters: 1) total number of robotic toy devices that are wirelessly connected via the established wireless network; 2) the cost of the hardware and/or software needed to implement the process; and/or 3) the environment or area in which the method is to be used.

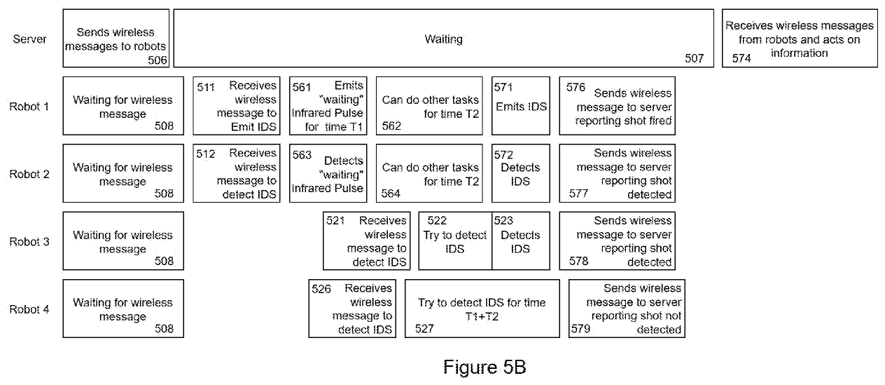

FIG. 5A illustrates a method of scheduling communications between a network of connected toy robot devices according to embodiments. FIG. 5B illustrates a timing diagram associated with the method of scheduling communications described in FIG. 5A according to some embodiments. In some embodiments, the line-of-sight between connected robotic toy devices in the established wireless communications network may be checked. In some embodiments, a server toy robotic device may utilize the established wireless network to send, transmit or communicate 505 a message to all the connected toy robotic devices (e.g., the server robotic device and/or the client robotic devices that have been verified as part of the established wireless communication network discussed above with respect to FIG. 4A). In some embodiments, the server toy robotics device transmission may optionally include a shot identification code, value or parameter. In some embodiments, the server toy robotics device transmission may include other parameters or values that are important to allow the robotic toy devices to schedule other operations.

In some embodiments, a toy robotic device may receive the communicated message (e.g., a client toy robotics device may receive the communicated message). In some embodiments, the toy robotic device may determine or analyze 510 whether the toy robotic device has been instructed to fire a shot from the server toy robotic device.

In some embodiments, if the toy robotic device has been instructed or commanded to fire a shot, then the toy robotic device may communicate, transmit or send 560 a waiting infrared pulse. In some embodiments, the waiting infrared pulse may be sent or transmitted for a certain period of time (e.g., which may be a time T1). In some embodiments, after transmitting the infrared waiting pulse, the toy robotic device may wait a specified or predetermined time (which may be T2) to allow for all of the robotic toy devices on the established wireless network to have received the original waiting infrared pulse 565. In some embodiments, the toy robotic device may then transmit the digital infrared signal (IDS) 570 (e.g., which may represent the firing shot). In some embodiments, the toy robotic device may use the established wireless network to notify the server toy robotic device that the infrared signal (IDS) was transmitted or sent (or fired) 575. In some embodiments, the time (T1+T2) may be application dependent and/or game dependent and may be adjusted accordingly. In other words, the pulse time and the waiting time before the fired IDS may be adjustable and this may depend on hardware configurations, game parameters, and/or user identified limitations. In some embodiments, the time T1+T2 may be represent an approximate maximum amount of time it takes for a wireless message to be transmitted from the server robotic toy robotic device to be received and processed by the client toy robotic devices via the wireless communication network.

In some embodiments, if a toy robotic device has not been told or instructed to fire a shot, then the robotic toy device may attempt to try to detect 515 a digital infrared signal for a set or pre-established amount of time. In some embodiments, the robotic toy device may determine if it receives and/or senses 520 the infrared “waiting pulse” from one of the other toy robotic devices. In some embodiments, if the robotic toy device receives or senses the infrared “waiting pulse,” the toy robotic device may know a time period or timeframe 525 in which the infrared signal may be coming or received. In some embodiments, the toy robotic device that sensed the infrared waiting pulse may utilize the time period to perform and/or execute 530 other critical tasks (if necessary), instead of just waiting for the infrared digital signal to be transmitted or received. In some embodiments, the other essential or critical tasks may be audio processing sound for sound effects, reading and capturing measurements on the one or more gyroscopes and/or accelerometers; activating the motors on the toy robotic device and/or changing the lighting effects on the toy robotic device. In some embodiments, other essential and/or critical tasks may be reading and/or capturing RFID tags and/or RFID transmitters, wirelessly processing any received messages and/or executing any game-related computer-readable instructions.

In some embodiments, a toy robotic device may sense and/or receive a digital infrared signal before the predetermined time period 535 (e.g., before running out of time for the predetermined time period). In some embodiments, the toy robotic device that receives and/or senses the infrared signal may determine 540 a direction from which the infrared signal came from based, at least in part, on which internal infrared receivers (or sensors) detected and/or received the signal (e.g., IDS) and/or brightness or intensity of the received IDS signal. In some embodiments, the toy robotic device may use the established network to notify the server toy robotic device of detection of the infrared signal and the direction 545 of the received infrared signal. In some embodiments, the above-identified actions may result in the server toy robotic device having information with respect to line-of-sight 555 about the toy robotic device that fired and other connected robotic toy devices in the established wireless network. In some embodiments, if the toy robotic device does not sense the digital infrared signal in the designated time period, then the toy robotic device may utilize the established wireless network to notify 550 the server toy robotic device that the infrared signal was not received correctly or that the predetermined time period ran out.

In FIG. 5B, an example of the process is illustrated for a certain timeframe. In FIG. 5B, a horizontal axis is time, with the left side of the horizontal axis being earlier in time and the right side of the horizontal axis being later in time. In some embodiments, the message sent by the server toy robotic device via the established wireless network may be illustrated by reference number 506. In some embodiments, the server toy robotic device may then wait for a period of time, which may be a set period of time, as illustrated by reference number 507. In some embodiments, the other toy robotic devices (e.g., which may be client toy robotic devices) may be waiting for a server toy robotic toy device to transmit a message utilizing the established wireless communications network (which is illustrated by reference number 508 for the four robotic toy devices (e.g., Robot 1, Robot 2, Robot 3, and/or Robot 4).

In some embodiments, as illustrated in FIG. 5B, for example, Robot 1 may receive a fire and/or emit message 511 via the established wireless network from the server robotic device. In some embodiments, the fire message may be referred to as an emit infrared digital signal (IDS). In some embodiments, as illustrated in FIG. 5B, for example, Robot 2 may receive a receive or detect message 512 via the established wireless network from the server toy robotic device. In some embodiments, the receive message may be referred to as a detected infrared digital signal (IDS).

In some embodiments, as illustrated in FIG. 5B, Robot 1 may emit a waiting infrared pulse 561 for a specified time (e.g., T1). In some embodiments, Robot 1 may perform other tasks 562 for a different specified time (e.g., T2). Similarly, as illustrated in FIG. 5B, Robot 2 may detect the waiting infrared pulse from Robot 1 563 during time T1 or around the time T1. In some embodiments, Robot 2 may perform other tasks during the specified time period (e.g., T2) when it is waiting 564 for the emitted infrared signal pulse. In some embodiments, the robotic toy device transmits, sends or communicates 570 the infrared digital signal. In some embodiments, as illustrated in FIG. 5B, the emitted IDS is communicated or sent by Robot 1, as illustrated by reference number 571. In some embodiments, Robot 2 may detect the sent or transmitted IDS, as illustrated by reference number 572. In some embodiments, toy robotic toy devices may not immediately receive the message sent by Robot 1. In some embodiments, as illustrated in FIG. 5B, Robot 3 may receive the message to detect the IDS at a later time than Robot 2 (as illustrated by reference number 521). In some embodiments, Robot 3 may then attempt to detect the IDS during a time period after a predetermined time (e.g., time T2), as illustrated by reference number 522. In some embodiments, Robot toy device 3 may detect the IDS emitted by Robot toy device 3, as illustrated by reference number 523. In some cases, the Robot may not detect the IDS because there is no line of sight or because maybe the Robot is not working properly. In some embodiments, as illustrated in FIG. 5B, Robot 4 may receive the wireless message to detect the emitted IDS, as illustrated by reference number 526. However, Robot 4 may spend an amount of time and not be able to detect the IDS. For example, as illustrated by reference number 527, Robot 4 may try to detect the IDS for time periods T1 and T2, but may be unsuccessful. In some embodiments, the robotic toy device(s) may then utilize the established wireless network to notify the server robotic toy device that the infrared signal was sent, transmitted or communicated. In some embodiments, the robotic toy devices may have different messages that a transmitted to the server robotic toy device. In some embodiments, as illustrated in FIG. 5B, for example, Robot 1 may communicate or send a message to the server robotic device identifying or indicating a shot was fired by Robot 1, as illustrated by reference number 576. For example, Robot 2 may communicate or send a message to the server robotic device identifying or indicating that the shot fired by Robot 1 was detected, as illustrated by reference number 577. For example, Robot 3 may communicate or send a message to the server robotic device identifying or indicating that the shot fired by Robot 1 was detected or received, as illustrated by reference number 578. For example, Robot 4 may communicate or send a message to the server robotic toy device identifying or indicating that the shot fired by Robot 1 was not detected, as illustrated by reference number 579 (which may indicate that Robot 4 is not in line of sight of Robot 1.) In some embodiments, the server robotic device may receive the messages transmitted or sent 574 via the established wireless communication network from the connected toy robotic devices (e.g., Robots 1, 2, 3 or 4) and perform actions based on the information and/or parameters received.

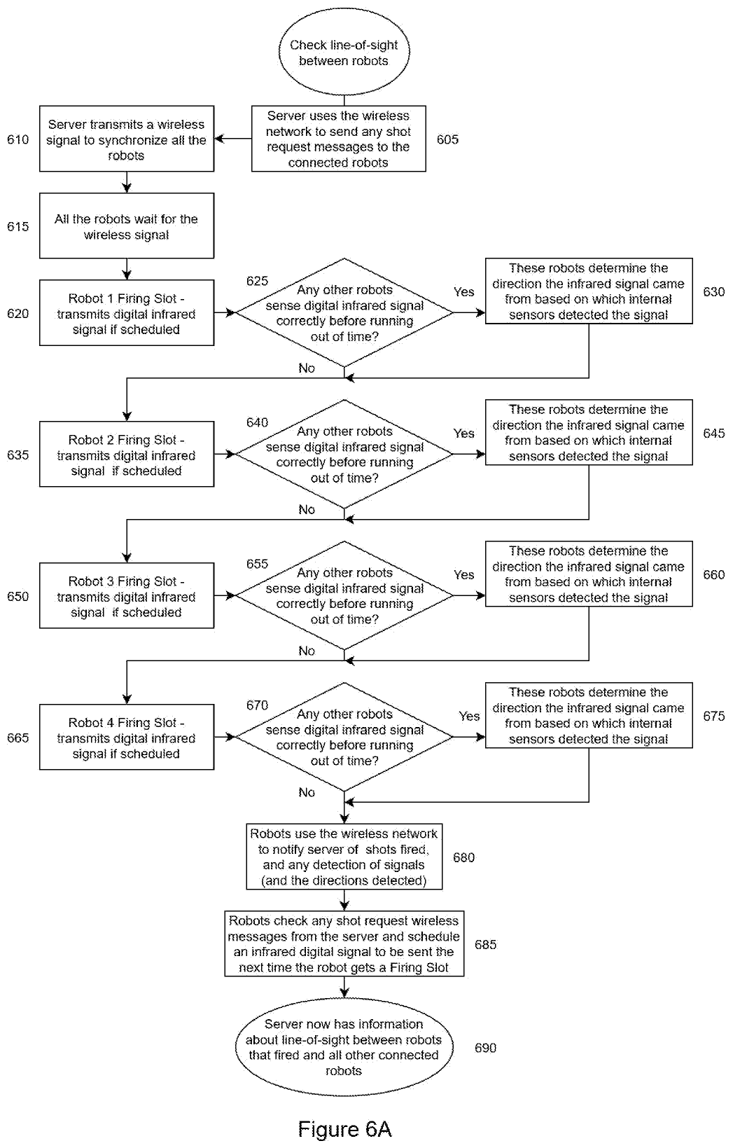

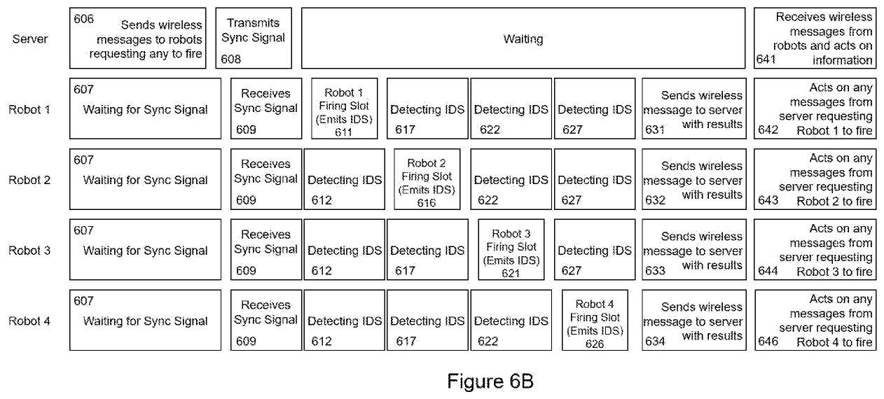

FIG. 6A illustrates an additional method or process of identifying line of sight between robotic toy devices according to some embodiments. In some embodiments, in order to implement the additional method or process, the server toy robotic device and/or the client toy robotic devices may utilize additional software and/or hardware in order to allow for more shots or shot IDS to be fired and/or detected in a quicker timeframe. In some embodiments, in order to implement the additional method or process, each toy robotic device (e.g., server toy robotic device, base station device, and/or client toy robotic device) may comprise an additional wireless signal transmitter and/or an additional wireless signal receiver. In some embodiments, the additional wireless signal transmitter and/or receiver may be one device and may be a wireless signal transceiver. In some embodiments, other technologies may be utilized as alternatives to cellular wireless technology, PAN wireless technology and/or WiFi or 802.11 wireless communication technology. In some embodiments, these other wireless communication technologies may be radiofrequency (RF) technology (utilizing an RF module); ultrasonic wave technology (utilizing an ultrasound sound module); and/or magnetic pulses (utilizing a magnetic pulse module). In some embodiments, if a base station device is utilized then the additional hardware and/or software may be limited to an additional wireless signal transmitter in the base station device and additional wireless signal receivers in each client robotic device. In some embodiments, this additional method or process utilizes that there is a constant time between transmission of the wireless signal and reception of the transmitted wireless signal. This constant time will vary based on the wireless communication technology utilized but will be a constant or known relationship with little variance (e.g., may vary within narrow time limits). In some embodiments, this wireless signal may be a synchronization signal or sync signal. In some embodiments, the process described in FIGS. 6A and 6B may allow a faster shot firing rate, but maybe a more expensive solution, than the one described in FIGS. 5A and 5B.

In some embodiments, the server toy robotic device may utilize the established wireless communication network to communicate, transmit or send a shot request message 605 to the toy robotic devices connected to the established wireless network. In some embodiments, the shot request message may include a shot identification code. In some embodiments, the server robotic device (or base station device) may transmit, send and/or communicate a synchronization signal via the established wireless network to synchronize 610 all of the robotic toy devices connected and/or coupled to the established wireless network. In some embodiments, the server toy robotic device may wait for a time (e.g., time T) after sending the sync signal. After the established time (e.g., T), the server toy robotic device and/or the client toy robotic devices may be synchronized. Accordingly, whatever actions the robotic toy devices take may occur at approximately the same time. In some embodiments, the synchronization signal may include timing details as to when specific toy devices may be able to communicate or transit a shot signal (e.g., may assign or identify timeslots for the specific toy devices on established wireless communication network). In some embodiments, the toy robotic devices may wait 615 for the infrared signal. In some embodiments, a first robotic device may communicate a firing shot (e.g., may transmit, send or communicate a digital infrared signal) if the scheduled timeframe for the first robotic toy device is occurring. In some embodiments, other toy robotic devices may sense 625 the transmitted and/or communicated digital infrared signal from the first robotic toy device before a predetermined timeframe. In some embodiments, the other toy robotic devices may determine a direction 630 of the received or sensed infrared signal is received from or came from based on which infrared receivers or sensors on the toy robotic device detected and/or received the transmitted digital infrared signal.

In some embodiments, a timeframe scheduled for the second robotic toy device may occur. In some embodiments, if the timeframe scheduled for the second robotic toy device occurs, the second robotic toy device may communicate, transmit or send 635 the digital infrared signal representing a shot signal. In some embodiments, other toy robotic devices may sense 640 the transmitted and/or communicated digital infrared signal from the second robotic toy device before a predetermined timeframe. In some embodiments, the other toy robotic devices may determine a direction 645 the received or sensed infrared signal is received from or came from based on which infrared receivers or sensors detected and/or received the digital infrared signal.

In some embodiments, a timeframe scheduled for a third toy robotic device may occur. In some embodiments, if the timeframe scheduled for the third robotic toy device occurs, the third robotic toy device may communicate, transmit or send 650 the digital infrared signal representing a shot signal. In some embodiments, other toy robotic devices may sense 655 the transmitted and/or communicated digital infrared signal from the third robotic toy device before a predetermined timeframe. In some embodiments, the other toy robotic devices may determine a direction 660 the received or sensed infrared signal is received from or came from based on which infrared receivers or sensors detected and/or received the digital infrared signal.

In some embodiments, a timeframe scheduled for a fourth toy robotic device may occur. In some embodiments, if the timeframe scheduled for the fourth robotic toy device occurs, the fourth robotic toy device may communicate, transmit or send 665 the digital infrared signal representing a shot signal. In some embodiments, other toy robotic devices may sense 670 the transmitted and/or communicated digital infrared signal from the fourth robotic toy device before a predetermined timeframe. In some embodiments, the other toy robotic devices may determine a direction 675 the received or sensed infrared signal is received from or came from based on which infrared receivers or sensors detected and/or received the digital infrared signal.

In some embodiments, the toy robotic devices (e.g., in this example, the first toy robotic device, the second toy robotic device, the third toy robotic toy device, and/or the fourth toy robotic device) may communicate, transmit or send to the server toy robotic device, via the established wireless communication network, shots fired (e.g., number of shots fired, the timeslot when the shots were fired, and/or timeframe when the shots were fired), any infrared sensor signals received or detected by the robotic toy devices, as well as a direction from which the infrared signals were received or detected 680. In some embodiments, the server toy robotic device (or base station device) may utilize the parameters, measurements and/or information in the messages transmitted back to determine which toy robotic devices were hit and/or at what angles the toy robotic devices were hit. In some embodiments, the server toy robotic device may be able or used to update the state of the game that the users are playing based at least in part on the information received.

In some embodiments, the toy robotic devices may check any shot request messages received from the server toy robotic device (via the established wireless communication network) and may schedule an infrared digital signal to be sent or transmitted a next time each of the robotic toy devices gets a scheduled timeframe or timeslot to communicate a firing shot (e.g., digital infrared signal) 685. Although it may seem counter-intuitive to check for wireless signals (or wireless messages) after the firing timeslots have been used, checking for wirelessly transmitted messages from the server toy robotic device or base station device does not take the constant amount of time, and the wirelessly transmitted messages don't take the constant amount of time to arrive. Thus, checking after all the synchronized actions have occurred or happened, mean that any delay to the messages doesn't impact or effect the synchronized actions. Accordingly, any wireless messages received by the toy robotic devices requesting a shot to be fired (e.g., a shot IDS) may be acted upon a next time the synchronized actions occur and the toy robotic device gets its next firing shot or (shot IDS). In some embodiments, after this has occurred, the server toy robotic device may move on to processing the next shot to be fired in the same way as described above in FIG. 6A and this additional process or method may repeat.

In some embodiments, the server robotic toy device now has information about line-of-sight between the server toy robotic devices that fired and/or other connected toy robotic devices (which also may be referred to as client toy robotic devices and/or also may include a server toy robotic device) 690.

FIG. 6B illustrates a timing diagram for the process discussed in FIG. 6A according to some embodiments. In some embodiments, a server toy robotic device may transmit, send or communicate wireless messages over an established wireless network to a number of robotic toy devices 606 requesting the robotic toy devices to fire. In some embodiments, as illustrated in FIG. 6B, there may be four robotic toy devices. In some embodiments, the four robotic devices (e.g., Robot 1, Robot 2, Robot 3 and/or Robot 4) may be waiting for a synch (or synchronizing) signal transmitted 607 from a server toy robotic device identifying when each of the toy robotic devices may fire (or emit an infrared signal). In some embodiments, a server toy robotic device may transmit, send and/or communicate the synch (or synchronizing) signal 608 to the plurality of robotic toy devices. In some embodiments, the plurality of robotic toy devices may receive the synch signal transmitted from server robotic toy devices 609 via the established wireless communication network, as illustrated FIG. 6B. In some embodiments, the synch (or synchronizing) signal may include information or parameters such as timeframes when each of the robotic toy devices may transmit a firing signal (e.g., an infrared digital signal). In some embodiments, in response to a timeframe established by the synch signal (which may be referred to as a firing time slot), Robot 1 may communicate, transmit or send a firing shot 611 (e.g., emit a firing infrared digital signal (IDS)) utilizing one or more of its infrared signal emitters. In some embodiments, the second, third and/or fourth toy robotic devices (e.g., Robots 2, 3 and 4) may have their infrared receivers attempt to detect 612 the transmitted IDS from the first robotic toy devices and may receive or detect the transmitted IDS (if the second, third and/or fourth toy robotic devices (e.g., Robots 2, 3 and 4) are in line-of-sight of the first robotic toy devices). In some embodiments, if the second, third and/or fourth toy robotic devices detect the first toy robotic device's transmitted IDS, the second, third and/or fourth toy robotic devices may record or store an indicator or identifier that the first toy robotic device (Robot 1) transmitted IDS was detected.

In some embodiments, in response to a timeframe established by the synch signal (which may be referred to as a firing time slot), a second toy robotic device (e.g., Robot 2) may communicate, transmit or send a firing shot 616 (e.g., emit a firing infrared digital signal (IDS)) utilizing one or more of its infrared signal emitters. In some embodiments, the first, third and/or fourth toy robotic devices (e.g., Robot 1, Robot 3 and/or Robot 4) may have their infrared receivers attempt to detect 617 the transmitted IDS from the second toy robotic devices and may receive or detect the transmitted IDS (if the first, third and/or fourth toy robotic devices are in line-of-sight of the second robotic toy device). In some embodiments, if the first, third and/or fourth toy robotic devices detect the second robotic toy device's transmitted IDS, the first, third and/or fourth toy robotic devices may record or store an indicator or identifier that the second robotic device transmitted IDS was detected.

In some embodiments, in response to a timeframe established by the synch signal (which may be referred to as a firing time slot), a third toy robotic device (e.g., Robot 3) may communicate, transmit or send a firing shot 621 (e.g., emit a firing infrared digital signal (IDS)) utilizing one or more of its infrared signal emitters. In some embodiments, the first, second and/or fourth toy robotic devices (e.g., Robot 1, Robot 2 and/or Robot 4) may have their infrared receivers attempt to detect 622 the transmitted IDS from the third toy robotic device and may receive or detect the transmitted IDS (if the first, second and/or fourth toy robotic devices are in line-of-sight of the third toy robotic device). In some embodiments, if the first, second and/or fourth toy robotic devices detect the third toy robotic device's transmitted IDS, the first, second and/or fourth toy robotic devices may record or store an indicator or identifier that the third toy robotic device transmitted IDS was detected.

In some embodiments, in response to a timeframe established by the synch signal (which may be referred to as a firing time slot), a fourth robotic device (e.g., Robot 4) may communicate, transmit or send a firing shot 626 (e.g., emit a firing infrared digital signal (IDS)) utilizing one or more of its infrared signal emitters. In some embodiments, the first, second and/or third toy robotic toy devices (e.g., Robot 1, Robot 2, and/or Robot 3) may have their infrared receivers attempt to detect 627 the transmitted IDS from the fourth robotic toy device and may receive or detect the transmitted IDS (if the first, second and/or third toy robotic devices are in line-of-sight of the fourth toy robotic device). In some embodiments, if the first, second and/or third toy robotic devices detect the fourth toy robotic device's transmitted IDS, the first, second and/or third toy robotic devices may record or store an indicator or identifier that the fourth toy robotic device transmitted IDS was detected.

In some embodiments, the toy robotic devices may gather the different results of transmitting or receiving IDS (e.g., shots fired and/or shots detected) and may transmit a results messages to the server toy robotic toy device via the established wireless communication network. In some embodiments, a first toy robotic device (Robot 1) may transmit or send 631 a results message to the server toy robotic device with the number of shots fired by the first toy robotic device and which shots from other toy robotic devices were received or detected. In some embodiments, a second toy robotic device (e.g., Robot 2) may transmit or send 632 a results message to the server toy robotic device with the number of shots fired by the second toy robotic device and which shots from other toy robotic devices were received or detected. In some embodiments, a third toy robotic device (e.g., Robot 3) may transmit or send 633 a results message to the server toy robotic device with the number of shots fired by the third toy robotic device and which shots from other toy robotic toy devices were received or detected. In some embodiments, a fourth toy robotic device (e.g., Robot 4) may transmit or send 634 a results message to the server toy robotic device with the number of shots fired by the fourth toy robotic device and which shots from other toy robotic devices were received or detected.

In some embodiments, as illustrated in FIG. 6B, for example, the server toy robotic device may receive the results messages from the one or more toy robotic toy devices and may act 641 on the contents within the results messages. In some embodiments, for example, a results message may indicate that a shot signal or firing shot has hit a specified toy robotic device. In response to this results message, a server toy robotic device processor may execute game-related computer-readable instructions related to the shot being fired. For example, if the specified robotic toy device has an active shield activated and/or deployed, the received firing shot may not do any damage to the specified toy robotic device, but the shield of the specified toy robotic device may lose power because the firing shot hit it. In some embodiments, if the specified toy robotic device does not have a shield, the server toy robotic device may update parameters and/or information for the specified toy robotic device in the one or more memory devices of the robotic toy device identifying that a shot (or shots) have hit and/or damaged the specified toy robotic device. In this embodiment, the server toy robotic device may generate instructions, commands and/or messages and may wirelessly communicate the instructions commands and/or messages to the specified toy robotic device to cause the specified toy robotic device to play a sound effect and/or to flash some lighting elements to indicate that the firing shot has hit the specified toy robotic device. In this embodiments, the server toy robotic device may also update a health parameter and/or status of the specified toy robotic device and/or may communicate the health parameter and/or status of the specified toy robotic device to other toy robotic devices on the established wireless network and/or controller devices on the established wireless communication network so that the controller devices may display a correct and/or real-time health status of the specified toy robotic device. In some embodiments, this allows the users and/or operators to take other actions accordingly. In some embodiments, the first toy robotic device may act 642 on any wireless messages from the server toy robotic device requesting the first toy robotic device to fire shots or emit IDS. In some embodiments, the second toy robot device may act 643 on any wireless messages from the server toy robotic device requesting the second toy robotic device to fire shots or emit an IDS. In some embodiments, the third toy robot device may act 644 on any wireless messages from the server toy robotic device requesting the third toy robotic device to fire shots or emit an IDS. In some embodiments, the fourth toy robotic device may act 646 on wireless messages from the server toy robotic device requesting the fourth toy robotic device to first shots or emit an IDS.

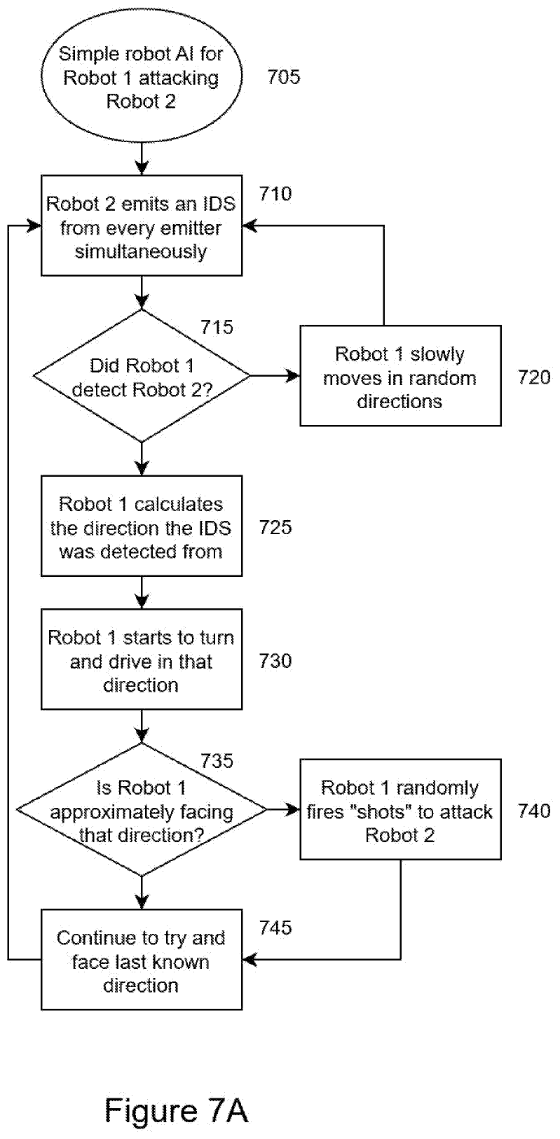

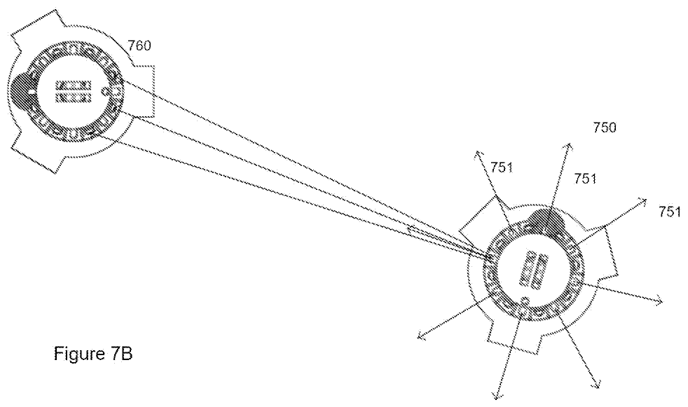

FIG. 7A illustrates a simple artificial intelligence process for toy robotic devices according to some embodiments. In some embodiments, one toy robotic device may follow another toy robotic toy device using a unique and novel method and/or process. In some embodiments, this process may allow a first toy robotic device to follow and attack 705 a second toy robotic device. In some embodiments, for example, a second toy robotic device may emit or transmit 710 an infrared signal from all of the second toy robotic device's emitters. FIG. 7B illustrates a second toy robotic device tracking and/or attacking a first toy robotic device according to some embodiments. As is illustrated in FIG. 7B, a second toy robotic device 750 may transmit a plurality of infrared signals 751 from its infrared emitters. In FIG. 7B, eight infrared emitters may transmit or communicate eight infrared signals. In some embodiments, the first toy robotic device's receivers may determine whether or not the infrared signal transmitted from the second toy robotic device's transmitters is detected 715. In some embodiments, if the first robotic device does not detect the infrared signal transmitted from the second robotic device, the first robotic device moves slowly in random directions 720. In some embodiments, the first toy robotic device may wait for another infrared digital signal to be transmitted from the second toy robotic device. In some embodiments, if the first toy robotic device detects and/or receives the IDS transmitted from the second toy robotic device, the first toy robotic device may determine and/or calculate the direction from which the second toy robotic device's IDS was detected or received by analyzing 725 which of its infrared receiver or receivers detected the IDS. In some embodiments, as illustrated by FIG. 7B, three infrared receivers on the first robotic device 760 may receive the infrared signal which allows the first toy robotic device 760 to determine which direction the second toy robotic device's IDS came from.

In some embodiments, in response to detecting which direction the second toy robotic device's IDS was emitted from, the first robotic toy device may begin to turn in the determined direction and/or may start to drive in the determined direction 730. In some embodiments, the first toy robotic device may calculate or identify 735 if the first toy robotic device is approximately facing the determined direction of the second toy robotic device. If the first toy robotic device determines that the first toy robotic device is approximately facing the determined direction, the first toy robotic device may begin to fire shots or transmit firing IDS in the determined direction (or approximately the determined direction) towards the second toy robotic device to attack 740 the second toy robotic device. In some embodiments, the first toy robotic device may then continue to try and face 745 the last known direction (e.g., which may be the determined direction).

In some embodiments, the AI or following/tracking process described in FIG. 7A may be utilized in a system that does not implement the processes or methods of FIGS. 5A and 5B or the processes or methods of FIGS. 6A and 6B. In some embodiments, the AI or following/tracking process may be utilized with the time slot scheduling process or methods described in FIGS. 5A and 5B as well as FIGS. 6A and 6B. In some embodiments, the AI or following/tracking process may be an example of how the time slot scheduling process or methods described above may be utilized. In some embodiments, the process described in FIG. 7A may also be utilized to see if shots have hit the toy robotic devices.

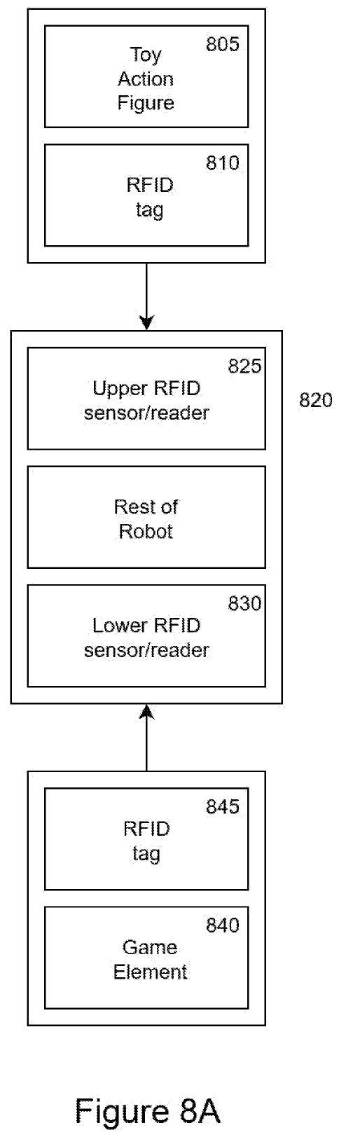

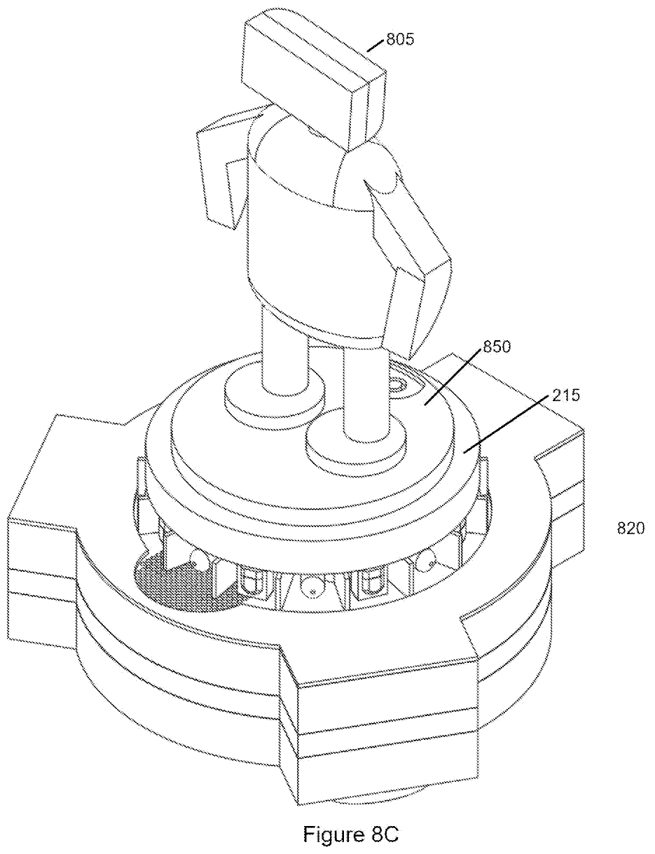

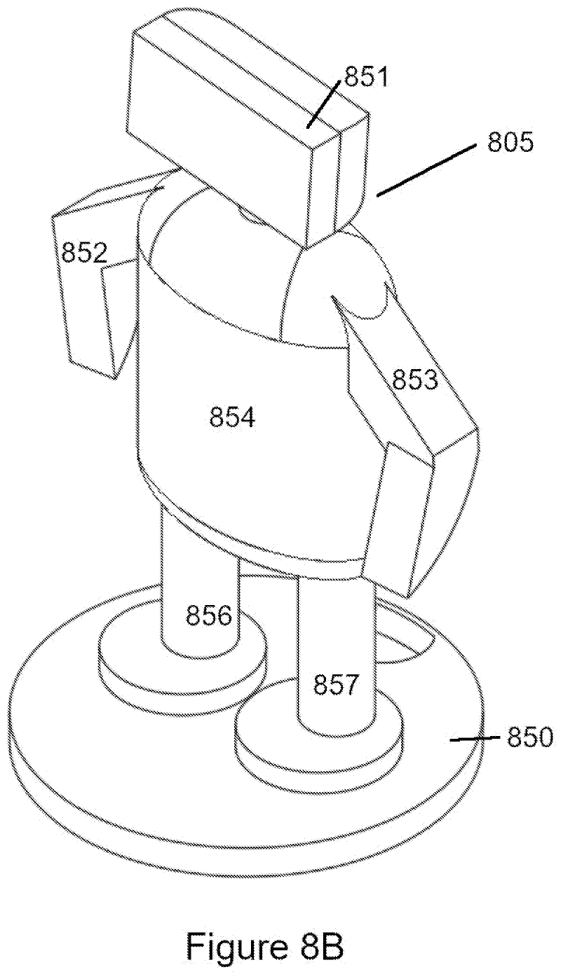

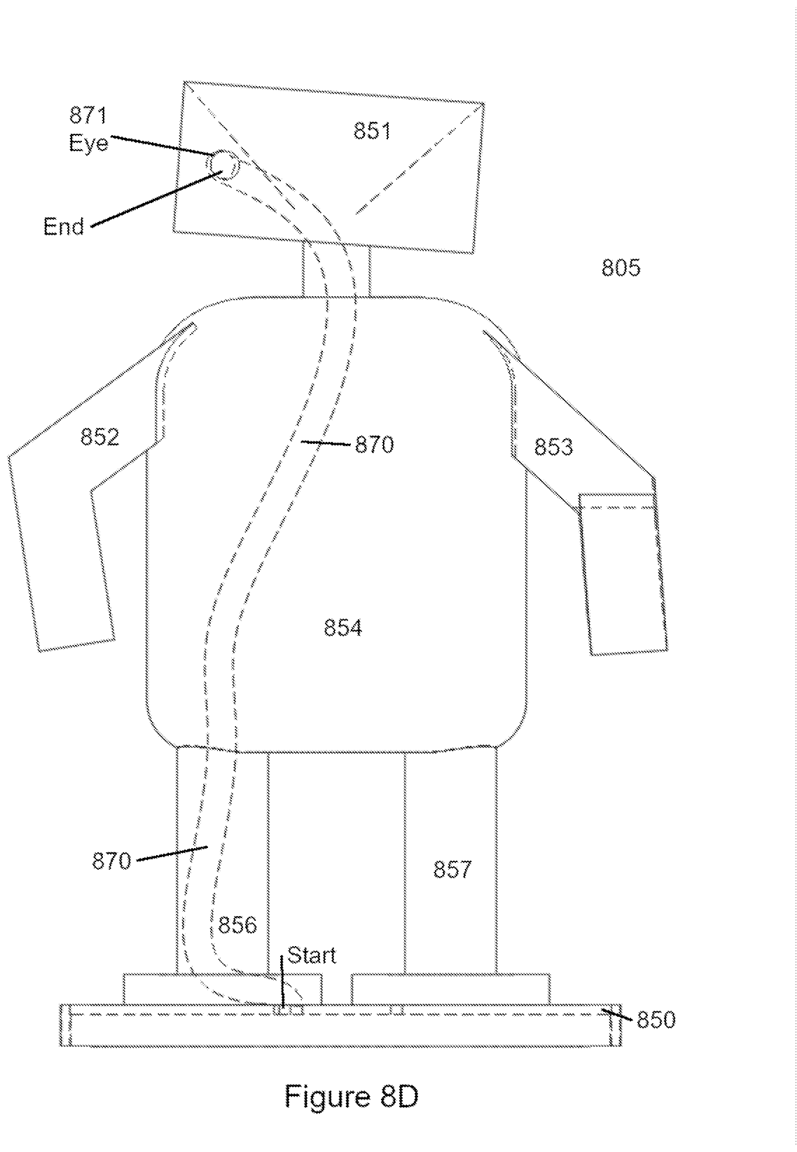

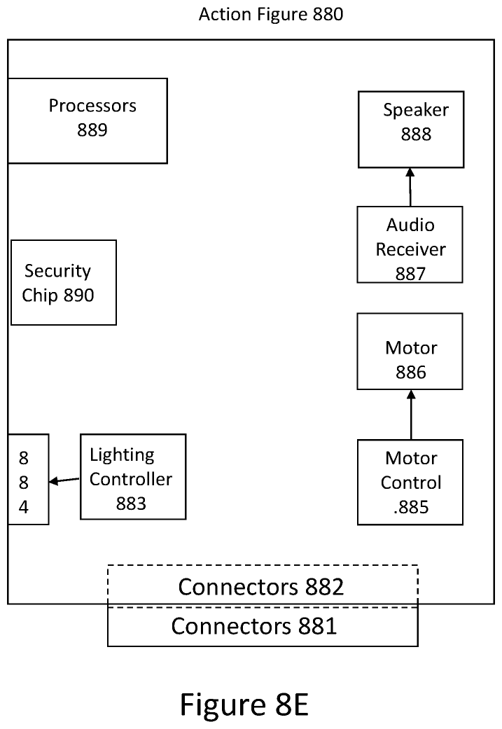

FIG. 8A illustrates coupling or connection of radio frequency identification (RFID) readers in a robotic toy device according to some embodiments. FIG. 8B illustrates a toy action figure according to some embodiments. FIG. 8C illustrates a toy action figure attached or connected to a top surface of the toy robotic device according to some embodiments. In some embodiments, the robotic toy device may be configured so that a toy action figure may be attached, coupled or connected to a top surface of the toy robotic device. In some embodiments, different types of action figures may be attached, coupled and/or connected. In some embodiments, this means different types of RFID transmitters may be integrated within the action figure or attached, coupled or connected to the associated toy action figure. In some embodiments, the toy robotic toy device may comprise an RFID reader. In some embodiments, the toy action figure 805 may comprise a RFID tag or transmitter 810. In some embodiments, the toy robotic device 820 may comprise an upper RFID sensor or reader 825 and/or a lower RFID sensor or reader 830. In some embodiments, a game element device 840 may comprise an RFID tag or transmitter 845. In some embodiments, each different type of action figure (e.g., Action Figure A, Action Figure B, Action Figure C) may be sensed by the upper RFID sensor or reader 825 of the toy robotic device 820. In some embodiments, for example, an RFID tag or transmitter (e.g., tag 810) in a base of an action figure may be read by the upper RFID sensor or reader 825 of the toy robotic device 820.

In some embodiments, a camera or scanner in a top portion of a robotic toy device may read a bar code, color pattern and/or QR code attached to a bottom surface of an action figure, which may be an action figure identifier or parameter. Thus, in these embodiments, the RFID reader and/or RFID tag/transmitter may not be needed to identify the action figure. In some embodiments, a configurable toy apparatus includes a toy robotic device and an action figure. In some embodiments, the toy robotic device includes a bar code reader, a QR code reader or a camera and an infrared transmitter. In some embodiments, the toy robotic device includes one or more processors; one or more memory devices; and computer-readable instructions stored in the one or more memory devices. In some embodiments, the toy robotic device includes an action figure. In some embodiments, the action figure includes a bar code or a QR code, and an action figure body. In some embodiments, the QR code reader or bar code reader may read the bar code or QR code and retrieve a value, and in response to the reading of the value, the software will compare the value to the stored action figure values representing characteristics of action figures and modify operational characteristics of the infrared transmitter based on the read value. In some embodiments, a color sensor may read a color code and operate in a similar fashion.

In some embodiments, a toy apparatus includes a toy robotic device and an action figure. The toy robotic device includes a plurality of first electrical contacts on a top surface of the toy robotic device; an electrical switching assembly connected to the plurality of electrical contacts; processors; memory devices; and computer-readable instructions stored in the one or more memory devices. The action figure includes a plurality of second electrical contacts, an action figure body and an integrated circuit or read only memory device. The plurality of the second electrical contacts connect to the plurality of first electrical contacts and in response to the connection, the computer-readable instructions are executable by the processors read a value in the integrated circuit or read-only memory device. In response to the reading of the value, the computer-readable instructions are executable by the processors to compare the value to stored action figure values representing characteristics of the action figure and to modify operational characteristics of components or assemblies of the toy robotic device based on the value.

FIG. 8B illustrates an action figure. In FIG. 8B, the action figure may comprise a head 851, a body 854, two arms 852 and 853, and two legs 856 and 857. In some embodiments, the action figure may comprise a base plate 850. FIG. 8C illustrates an action figure attached to a top surface of the robotic toy device. In some embodiments, the action figure 805 may comprise a base plate 850 which may be attached, coupled, or connected to a top surface of the toy robotic device. FIGS. 8B, 8C and/or 8D are just illustrative representations of an action figures. In some embodiments, action figures may also include vehicles and/or spaceships. In these embodiments, the parts of the vehicles and/or spaceships may include a body, one or more wings, and/or a hatch or capsule where a driver or operator is positioned. The discussions above and/or below regarding action figures also are applicable to action figures are vehicles and/or spaceships.

In some embodiments, computer-readable instructions executable by one or more processors of the toy robotic device may read the action figure identifier or parameter and retrieve configuration parameters associated with the action figure identifier and/or parameter from a memory device. In some embodiments, one or more memory devices may store action figure identifiers or parameters and/or associated configuration parameters for the action figures. In some embodiments, the configuration parameters may represent mannerisms, characteristics and/or abilities of the attached or connected action figure. In some embodiments, for example, if a first action figure type may have rocket boots for simulated propulsion and a shotgun for firing shots, the robotic toy device could read the action figure identifier or parameter (e.g., action figure type 1) and may retrieve configuration parameters so that the toy robotic device may change its movement speed to be faster. In addition, based on the retrieved configuration parameters, the toy robotic device may 1) use the front, front-left and/or front-right infrared emitters to emit and/or fire weapon shots; 2) reduce a rate of firing; and/or 3) reduce a brightness of the infrared emitters transmission brightness so that the emitted light may not be detected from the toy robotic devices further than a short distance away. In some embodiments, for example, a second action figure type may be a giant with a sniper rifle. In some embodiments, the toy robotic device could read the action figure identifier or parameter (e.g., action figure type 2) and may retrieve configuration parameters base on the action figure identifier or parameter. In some embodiments, the toy robotic device may move at a slow speed based on the retrieved configuration parameters associated with action figure type 2. In some embodiments, the toy robotic device may only utilize the front infrared emitter for firing to simulate a narrower shot based on the retrieved configuration parameters (which identify a long range rifle is being utilized). In some embodiments, the toy robotic device may have a slow rate of fire and a large brightness for the infrared emitters to make the fired shots simulated to be a long range, based on the retrieved configuration parameters.

In some embodiments, the following mannerisms or attributes may be changed based on different action figure identifiers and/or configuration parameters: robotic toy device movement speed, audio level of firing shots, brightness of infrared emitters (e.g., firing shots), rate of firing shots, and/or which infrared emitters are utilized. In some embodiments, additional mannerisms and/or attributes that may be changed based on different action figure identifiers and/or configuration parameters may be 1) types of shields a toy robotic device and action figure has, how strong the shields are, and/or the directions the shields are facing; 2) types of special attacks and/or defenses the toy robotic device/action figure may utilize (e.g., an Electro-magnetic pulse blast, a self-destruct sequence, a rapid fire mode, a stun bomb weapon, and/or an ability to replenish a teammates health parameters and/or status); 3) ammunition counts for each of the toy robotic device/action figure's weapons and/or a reload speed for the weapons; 4) a maximum health level, status and/or parameters for the toy robotic device/action figure; and 5) a type of Artificial Intelligence (AI) behavior, a toy robotic device/action figure may exhibit such as chase speed, shot accuracy, shot rate and/or patrolling behavior (along with other AI behaviors of the toy robotic device).

FIGS. 2A and 2B illustrates a top surface of the toy robotic device. In some embodiments, a toy robotic device top surface may comprise one or more lighting elements. In FIG. 2B, eight lighting elements are illustrated. In some embodiments, the lighting elements may be Red Green Blue (RGB) light emitting diodes (LEDS). In some embodiments, computer-readable instructions executable by one or more processors in the robotic toy device may identify which of the lighting elements are activated and/or transmit light.

In some embodiments, the action figure may comprise one or more light pipes or light channels. FIG. 8D illustrates light pipes in a toy action figure according to some embodiments. In some embodiments, when an action FIG. 805 is attached or coupled to the top of the toy robotic device, the one or more lighting elements may be aligned to associated one or more light pipes 870. In some embodiments, the one or more light pipes or channels 870 may start at a base of the action figure and may have an ending point at a hand, eye, face or other part of the action FIG. 805. In some embodiments, the light pipes 870 may be made of a plastic, an acrylic and/or a composite material. In some embodiments, the one or more light pipes 870 may channel light from the lighting elements through a body portion of the action figure to the different ending points (e.g., body parts) of the action figure. In some embodiments, this allows light originally emitted from the one or more lighting elements to be emitted and/or displayed at the different body parts of the action figure.

As illustrated in FIG. 8D, the lighting elements may emit light that may cause an action figure's eyes to emit light (e.g., an action figure is emitting a laser shot from its eyes). Thus, in some embodiments, a lighting element (positioned below a light pipe 870) may flash indicating and/or identifying that an action figure's eyes are to flash to show a laser is being fired. In some embodiments, as illustrated in FIG. 8D, the light emitted from the lighting element may travel and/or pass through the light pipe 870 in order to reach the action figure's eyes. In this embodiment, the light pipe 870 may pass through several sections of the action figure. As illustrated in FIG. 8D, the light pipe 870 may pass through an action figure leg 856, an action figure body 854, and/or an action figure 851 on way to the action figure eye 871.

In some embodiments, for example, the lighting elements may emit light corresponding to shots being fired. In other words, when shots are being fired, a first lighting element may flash and/or a second lighting element may flash at the robotic toy device. In some embodiments, the action figure may have two associated light pipes or channels. In some embodiments, the two associated light pipes or channels may travel through the action figure and end at two different hands on the action figure and the action figure may have a gun in each hand. Thus, when the robotic device lighting elements emit light or flash, the guns at the end of the action figures hand light up to simulate shots being fired.

In some embodiments, for example, an action figure may have a transparent cylinder that may simulate a shield for the action figure. In some embodiments, a plurality of lighting elements may emit lights based on commands or instructions from the toy robotic device. In some embodiments, each of the plurality of lighting elements may correspond to a portion of the transparent cylinder and thus may illuminate that portion of the transparent cylinder. In some embodiments, four lighting elements may be illuminated. In some embodiments, one lighting element may be illuminated. In some embodiments, each lighting element may correspond to or be associated with a quarter of the transparent cylinder. Thus, if four lighting elements are emitting light, then the entire transparent cylinder may illuminate which may simulate a protective electric shield being placed around the action figure. Similarly, if one lighting element is emitting light, the associated portion of the transparent cylinder may be illuminated simulating a protective shield being placed in front of an action figure from one direction.

In some embodiments, for example, an action figure may have a unique arrangement of light pipes or channels. In some embodiments, the toy robotic device may detect or identify which action figure is attached or connected, the toy robotic device can then emit patterns or colors of lights to match the characteristics, features and/or mannerisms of the action figure that is attached and/or connected.

FIG. 8E illustrates a block diagram of an action figure according to some embodiments. In some embodiments, action figures attached to the toy robotic device may also have include mechanical assemblies, electrical assemblies, and/or electrical or mechanical components. In some embodiments, this may allow the action figures to perform additional actions when connected to the toy robotic device. In some embodiments, the action figure's mechanical assemblies, electrical assemblies and/or other electrical or mechanical components may not operate unless electrically and/or mechanically connected to the toy robotic device.

In some embodiments, a top surface of the toy robotic device may further comprise a one or more electrical contacts 881. In some embodiments, a bottom surface of the action figure may have similar and/or matable electrical contacts 882 on a bottom surface of an attached, connected or coupled action figure. In some embodiments, the connection of the toy robotic device electrical contacts 881 to the action figure electrical contacts 882 may allow signals, commands and/or instructions to be transferred from the toy robotic device to action figure. In some embodiments, computer-readable instructions executable by the one or more processors of the toy robotic device may cause the one or more processors to communicate or transmit instructions, commands and/or signals through a circuit or trace or other electrical connections (e.g., cables, wires, etc.) to mechanical assemblies, electrical assemblies and/or other electrical or mechanical components in the action figure, which may cause these mechanical assemblies, electrical assemblies and/or other electrical or mechanical components in the action figures to perform certain actions. In some embodiments, electrical contacts on top of the toy robotic device 820 may align with similar electrical contacts in a base of the action figure.

In some embodiments, a toy apparatus includes a toy robotic device and an action figure. In some embodiments, the toy robotic device includes a plurality of first electrical contacts on a top surface of the toy robotic device; an electrical switching assembly connected to the plurality of electrical contacts; processors; memory devices; and computer-readable instructions stored in the memory devices. In some embodiments, the action figure includes a plurality of second electrical contacts; an action figure body; an electrical or mechanical driver assembly; and an electrical or mechanical component or assembly. In some embodiments, the plurality of the second electrical contacts connect to the plurality of first electrical contacts and in response to the connection, the computer-readable instructions are executable by the processors activate the switching assembly to cause a signal or command to be communicated to the electrical or mechanical driver assembly in the action figure to activate the electrical or mechanical component or assembly.

In some embodiments, the action figure mechanical assemblies, electrical assemblies and/or other electrical or mechanical components may include: 1) lighting circuits 883 and lighting elements 883; 2) motor controllers 885 and/or motor assemblies (e.g., server motors) 886; 3) microcontrollers, microprocessors, and/or controllers 889; 4) audio receivers 887 and/or speakers 888; and/or 5) additional security chips 890. In some embodiments, for example, computer-readable instructions executable by the one or more processors of the toy robotic device may control the lighting controller 883 and/or lighting elements 884 (e.g., LEDs) within the action figure 805 and change colors and/or brightness of the lighting elements in the action figure by transmitting signals, commands and/or instructions to the action figure through the completed circuit, trace, cable and/or wire. In some embodiments, for example, computer-readable instructions executable by the one or more processors of the toy robotic device may control motor controllers 885 and/or motor assemblies 886 within the action figure to activate one or more of the motor assemblies 886 to cause the action figure to perform movements like moving an arm up or down or to move a head up and done. In some embodiments, the signals, commands and/or instructions may be communicated to one or more of the motor controllers 885 and then to the one or more motor assemblies 886 through the completed circuit, trace, cable and/or wire if the toy robotic device electrical contacts 881 are connected to the action figure electrical contacts 882. In some embodiments, for example, computer-readable instructions executable by the one or more processors of the toy robotic device may communicate with a security integrated circuit or chip 890 within the action figure to read the necessary information or parameters. In some embodiments, the security chip 890 may be read if the toy robotic device electrical contacts 881 are connected to the action figure electrical contacts 882. In some embodiments, the security chip 890 may include an encryption code or other security identifier to instruct the toy robotic device a method of communicating with the action figure. In some embodiments, the security chip 890 may storage a simple number and/or alphanumeric value which the computer-readable instructions executable by one or more processors of the toy robotic device may verify using a validation process to verify the action figure is an acceptable or valid action figure and not a counterfeit action figure. In some embodiments, the toy robotic device may communicate a number and/or alphanumeric value to the action figure. In this embodiment, the security chip 890 and/or computer-readable instructions executable by one or more processors of the action figure may initiate a validation process and create a new number and/or alphanumeric value. In this embodiments, the security chip 890 of the action figure (along with computer-readable instructions executable by the one or more processors of the action figure) may communicate the new number and/or alphanumeric value to the toy robotic device, which may run a validation process to ensure the new number and/or alphanumeric value is acceptable. In some embodiments, these methods and/or processes may be used to validate that the action figure is a genuine accessory for the toy robotic device. The utilization of a genuine accessory prevents damage to the toy robotic device and/or also prevents copying and/or piracy of the action figures/toy robotic devices. In some embodiments, the security chip 890 of the action figure may comprise a value and the computer-readable instructions may be executable to retrieve this value from the security chip 890 and compare the security chip value to action figure values stored in the one or more memory devices of the toy robotic device in order to identify mannerisms, characteristics and/or parameters of the action figure. This means that the toy robotic device and/or the action figures may not need to have RFID readers and/or transmitters/tags, bar codes, QR codes and/or devices that read bar codes and/or QR codes.

In some embodiments, a method of transmitting light-based line-of-sight signals to schedule communications between a plurality of toy robotic devices includes receiving, at a first toy robotic device, a signal or command via a wireless communication network from a server toy robotic device, the signal command indicating the first toy robotic device is to transmit a signal representing a firing shot; transmitting, by the first toy robotic device, a waiting infrared pulse, via an infrared wireless network, to a remainder of the plurality of toy robotic devices, wherein the infrared wireless network is a different communication network than the wireless communication network; waiting a predetermined amount of time; transmitting, by the first toy robotic device, an infrared digital signal via the infrared wireless network, to the remainder of the plurality of toy robotic devices, wherein the infrared digital signal represents a firing shot from the first toy robotic device; and transmitting, by the first toy robotic device, a notification signal to the server toy robotic device to identify that the infrared digital signals representing the firing shot has been transmitted.

In some embodiments, a method of transmitting light-based line-of-sight signals to schedule communications between a plurality of toy robotic devices, comprising: receiving, at a first toy robotic device, a scheduling signal via a wireless communication network from a server toy robotic device, the scheduling signal identifying a timeslot in which the first toy robotic device may transmit an infrared digital signal, the infrared digital signal representing a firing shot; receiving, at the first toy robotic device, a synchronization signal via the wireless communication network from the server toy robotic device, the synchronization signal to synchronize a timing of the plurality of toy robotic devices; transmitting, by the first toy robotic device, an infrared digital signal via the infrared wireless network, to the remainder of the plurality of toy robotic devices during the identified timeslot, wherein the infrared digital signal represents a firing shot from the first toy robotic device; receiving, at the first toy robotic device, other infrared digital signals from the other toy robotic devices during additional timeslots, the other infrared digital signals being transmitted via the infrared wireless network; and transmitting, from the first toy robotic device to the server toy robotic device, a results message or signal, the first results message or signal being transmitted over the wireless communication network and identifying a number of infrared digital signals transmitted by the first robotic device and/or a number of other infrared digital signals being received from other toy robotic devices.

In some embodiments, a system includes a toy robotic device, the toy robotic device including a plurality of lighting elements disposed on a top surface of the toy robotic device; one or more processors; one or more memory devices; and computer-readable instructions stored in the one or more memory devices, the computer-readable instructions executable by the one or more processors to transmit signals and/or instructions to a lighting element of the plurality of lighting elements to activate the lighting element. In some embodiments, the system also includes an action figure, the action figure including an action figure body; and a light pipe, a first end of the light pipe starting at a bottom surface of the action figure and traveling through one portion of the action figure and terminating at a second end, the second end located in the action figure body. In some embodiments, the first end of the light pipe is aligned with the lighting element of the toy robotic device so that the light projected from the lighting element travels through the light pipe to the second end of the light pipe and illuminates a portion of the action figure body.

In some embodiments, a method for tracking a toy robotic device includes moving or rotating a first toy robotic device slowly; detecting, at one or more infrared receivers of a first toy robotic device, an infrared signal transmitted from a second toy robotic device; determining a direction from which the infrared signal was transmitted based at least in part on which of the one or more infrared receivers detected the transmitted infrared signal; generating instructions or commands to communicate to one or more wheel assemblies of the first robotic device to turn and/or move towards the determined direction; and generating instructions or commands and communicating the generated instructions or commands to the one or more infrared signal transmitters facing in the determined direction of the second toy robotic device.

As detailed above, the computing devices, servers, and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor. The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, controllers, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device or toy robotic device, may cause the computing device or toy robotic device to perform one or more tasks, such as the method step. In addition, one or more of the devices described herein may transform data, physical devices, and/or representations of physical devices from one form to another. Additionally, or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers (or computing devices or toy robotic devices), or be loaded and executed by one or more servers (or computing devices). One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server computing devices or toy robotic devices or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including,” “incorporating,” “includes,” “incorporates,” and “having” (and their derivatives), as used in the specification and claims, are interchangeable with and shall have the same meaning as the word “comprising.”

The processor as disclosed herein can be configured with instructions to perform any one or more steps of any method as disclosed herein. As used herein, the term “or” is used inclusively to refer items in the alternative and in combination. As used herein, characters such as numerals refer to like elements. Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. A method of transmitting light-based line-of-sight signals to schedule communications between a plurality of toy robotic devices, comprising:
receiving, at a first toy robotic device, a signal or command via a wireless communication network from a server toy robotic device;
transmitting, by the first toy robotic device, a waiting infrared pulse, via an infrared wireless network, to a remainder of the plurality of toy robotic devices, wherein the infrared wireless network is a different communication network than the wireless communication network, the transmitting of the waiting infrared pulse if the signal command indicates the first toy robotic device is to transmit a signal representing a firing shot;
waiting a predetermined amount of time;
transmitting, by the first toy robotic device, an infrared digital signal via the infrared wireless network, to the remainder of the plurality of toy robotic devices, wherein the infrared digital signal represents a firing shot from the first toy robotic device; and
transmitting, by the first toy robotic device, a notification signal to the server toy robotic device to identify that the infrared digital signals representing the firing shot has been transmitted.

2. The method of claim 1, wherein the signal command does not instruct the first toy robotic device to transmit the signal representing the firing shot, further comprising:
attempting to detect a digital infrared signal for a set amount of time.

3. The method of claim 2, wherein if the first toy robotic device detects a waiting pulse in the digital infrared signal, the first toy robotic device utilizes a time before a time period specified in the waiting pulse to perform other critical operational tasks.

4. The method of claim 2, wherein if the first toy robotic device detects the digital infrared signal in the set amount of time, further comprising:
determining a direction of the received digital infrared signal based, at least in part, on which internal infrared detectors sensed the digital infrared signal.

5. The method of claim 4, wherein the first toy robotic device transmits an additional notification signal to the server toy robotic device to indicate the direction of the received toy robotic digital infrared signal at the first toy robotic device.

6. The method of claim 3, wherein the other critical operational tasks include audio processing sound for sound effects or capturing gyroscope or accelerometer measurements.

7. The method of claim 3, wherein the other critical operational tasks include activating motors to prepare for movement or changing lighting effects of lighting elements.

8. A method of scheduling light-based line-of-sight signals for communications between a plurality of toy robotic devices utilizing other wireless communication protocols that are not light-based line-of-sight signals, comprising:
receiving, at a first toy robotic device, a scheduling signal via a wireless communication network from a server toy robotic device, the scheduling signal identifying a timeslot in which the first toy robotic device may transmit an infrared digital signal, the infrared digital signal representing a firing shot;
receiving, at the first toy robotic device, a synchronization signal via the wireless communication network from the server toy robotic device, the synchronization signal to synchronize a timing of the plurality of toy robotic devices;
transmitting, by the first toy robotic device, an infrared digital signal via the infrared wireless network, to the remainder of the plurality of toy robotic devices during the identified timeslot, wherein the infrared digital signal represents a firing shot from the first toy robotic device;
receiving, at the first toy robotic device, other infrared digital signals from the other toy robotic devices during additional timeslots, the other infrared digital signals being transmitted via the infrared wireless network; and
transmitting, from the first toy robotic device to the server toy robotic device, a results message or signal, the first results message or signal being transmitted over the wireless communication network and identifying a number of infrared digital signals transmitted by the first robotic device and/or a number of other infrared digital signals being received from other toy robotic devices.

9. The method of claim 8, wherein the first toy robotic device receives additional shot request messages from the server toy robotic device.

10. The method of claim 9, wherein the first toy robotic device schedules an additional infrared digital signal to be transmitted a next time period that the first robotic device is allocated a firing shot.

11. The method of claim 8, further comprising receiving, at a second toy robotic device, another synchronization signal via the wireless communication network from the server toy robotic device, the another synchronization signal to synchronize a timing of the plurality of toy robotic devices;
transmitting, by the second toy robotic device, another infrared digital signal via the infrared wireless network, to the remainder of the plurality of toy robotic devices during the identified timeslot, wherein the another infrared digital signal represents a firing shot from the second toy robotic device;
receiving, at the second toy robotic device, other infrared digital signals from the other toy robotic devices during additional timeslots, the other infrared digital signals being transmitted via the infrared wireless network; and
transmitting, from the second toy robotic device to the server toy robotic device, a second results message or signal, the second results message or signal being transmitted over the wireless communication network and identifying a number of infrared digital signals transmitted by the second robotic device and/or a number of other infrared digital signals being received from other toy robotic devices.

12. The method of claim 8, wherein the wireless communication network is a radio frequency network, an ultrasonic wave network or a magnetic wave network.

13. A method for tracking a toy robotic device, comprising:
moving or rotating a first toy robotic device slowly;
detecting, at one or more infrared receivers of a first toy robotic device, an infrared signal transmitted from a second toy robotic device;
determining a direction from which the infrared signal was transmitted based at least in part on which of the one or more infrared receivers detected the transmitted infrared signal;
generating instructions or commands to communicate to one or more wheel assemblies of the first robotic device to turn and/or move towards the determined direction; and
generating instructions or commands and communicating the generated instructions or commands to the one or more infrared signal transmitters facing in the determined direction of the second toy robotic device.

14. The method of claim 13, further comprising transmitting firing shots, via an infrared network, in the determined direction of the second toy robotic device.
